(19) United States
(12) Patent Application Publication
(10) Pub. No.: US 2013/0275650 A1
(43) Pub. Date: Oct. 17, 2013

(54) SEMICONDUCTOR STORAGE DEVICE

(71) Applicants: Toshikatsu Hida, Kanagawa (JP); Hiroshi Yao, Kanagawa (JP); Hirokuni Yano, Tokyo (JP)

(72) Inventors: Toshikatsu Hida, Kanagawa (JP); Hiroshi Yao, Kanagawa (JP); Hirokuni Yano, Tokyo (JP)

(73) Assignee: Kabushiki Kaisha Toshiba, Tokyo (JP)

(21) Appl. No.: 13/824,792

(22) PCT Filed: Dec. 14, 2011
(86) PCT No.: PCT/JP2011/079581

§ 371 Date: Jun. 12, 2013

(30) Foreign Application Priority Data
Dec. 16, 2010 (JP) 2010-280955
Jun. 28, 2011 (JP) 2011-143569

(51) Int. Cl. G06F 12/02

(52) U.S. Cl. CPC G06F 12/0246
USPC 711/102

(57) ABSTRACT

According to the embodiments, a first management table, which is included in a nonvolatile second semiconductor memory and manages data included in a second storage area by a first management unit, is stored in the second semiconductor memory and a second management table for managing data in the second storage area by a second management unit larger than the first management unit is stored in a first semiconductor memory capable of random access.

### CROSS-REFERENCE TO RELATED APPLICATIONS

This application is based upon and claims the benefit of priority from Japanese Patent Application No. 2010-280955, filed on Dec. 16, 2010 and Japanese Patent Application No. 2011-143569, filed on Jun. 28, 2011; the entire contents of all of which are incorporated herein by reference.

### FIELD

The present embodiments typically relate to a semiconductor storage device that includes a nonvolatile semiconductor memory.

### BACKGROUND

In an SSD (Solid State Drive), a data management mechanism that manages a location in a NAND flash memory to record data of a logical address specified by a host and selection of a unit for managing user data greatly affect a read and write performance and the life of a NAND flash memory.

### BRIEF DESCRIPTION OF THE DRAWINGS

FIG. 1 is a functional block diagram illustrating a configuration example of an SSD in a first embodiment.

FIG. 2 is a diagram illustrating an LBA logical address.

FIG. 3 is a block diagram illustrating a functional configuration formed in a NAND memory.

FIG. 4 is a diagram illustrating a configuration example of management tables.

FIG. 5 is a diagram illustrating an example of a WC management table.

FIG. 6 is a diagram illustrating an example of a track management table.

FIG. 7 is a diagram illustrating a forward-lookup cluster management table.

FIG. 8 is a diagram illustrating a volatile cluster management table.

FIG. 9 is a diagram illustrating a reverse-lookup cluster management table.

FIG. 10 is a diagram illustrating an example of a track entry management table.

FIG. 11 is a diagram illustrating an example of an intra-block valid cluster number management table.

FIG. 12 is a diagram illustrating an example of a block LRU management table.

FIG. 13 is a diagram illustrating an example of a block management table.

FIG. 14 is a flowchart illustrating an operation example of read processing.

FIG. 15 is a diagram conceptually illustrating an address resolution.

FIG. 16 is a diagram conceptually illustrating an address resolution.

FIG. 17 is a diagram conceptually illustrating an address resolution.

FIG. 18 is a flowchart illustrating an operation example of write processing.

FIG. 19 is a diagram conceptually illustrating organizing of a NAND memory in a busy state.

FIG. 20 is a diagram conceptually illustrating organizing of a NAND memory in a non-busy state.

FIG. 21 is a flowchart illustrating an operation example of organizing of a NAND memory.

FIG. 22 is a functional block diagram illustrating a configuration example of an SSD in the second embodiment.

FIG. 23 is a flowchart illustrating another operation example of organizing of a NAND memory.

FIG. 24 is a block diagram illustrating another functional configuration formed in a NAND memory.

FIG. 25 is a block diagram illustrating another functional configuration formed in a NAND memory.

FIG. 26 is a flowchart illustrating another flush processing of a NAND memory.

FIG. 27 is a flowchart illustrating another flush processing of a NAND memory.

FIG. 28 is a flowchart illustrating another flush processing of a NAND memory.

FIG. 29 is a flowchart illustrating another flush processing of a NAND memory.

FIG. 30 is a perspective view illustrating appearance of a personal computer.

FIG. 31 is a diagram illustrating a functional configuration example of a personal computer.

### DETAILED DESCRIPTION

According to embodiments, a first storage area included in a first semiconductor memory capable of random access, a second storage area included in a nonvolatile second semiconductor memory in which reading and writing is performed by a page unit and erasing is performed by a block unit larger than the page; and a controller that allocates a storage area of the second semiconductor memory to the second storage area by a block unit are included. The controller records a first management table for managing data in the second storage area by a first management unit, into the second semiconductor memory, and records a second management table for managing data in the second storage area by a second management unit larger than the first management unit, into the first semiconductor memory. The controller performs a data flush processing of flushing a plurality of data in a sector unit written in the first storage area to the second storage area as any one of data in the first management unit and data in the second management unit and updates at least one of the first management table and the second management table, and, when a resource usage of the second storage area exceeds a threshold, performs a data organizing processing of collecting valid data from the second storage area and rewriting into another block in the second storage area and updates at least one of the first management table and the second management table.

As a management system of an SSD, when a management unit that is small in size is employed as a unit of managing user data, a high read and write performance can be achieved even when writing (wide-area random write) with no locality of reference is continued successively by managing the whole SSD uniformly in small management units. However, when generating a large capacity SSD, there is a problem in that the capacity of a management information storage buffer for temporarily recording management information becomes enormous because a management unit is small.

On the other hand, in the SSD, in a system of performing control by combining two units, i.e., a large management unit and a small management unit, as a unit of managing user data, even when the capacity of the management information storage buffer is small, a high read and write performance and a long life can be achieved. However, in this system, because there is a limit on a data amount that can be managed in small units, when the wide-area random write is continued successively, conversion from a small management unit to a large management unit necessarily occurs, which may decrease the write speed.

Therefore, in the present embodiment, the following controls are performed.
Two units, i.e., a large management unit (second management unit) and a small management unit (first management unit) are provided as a unit of managing user data
When the access frequency from a host is high, an operation is performed by using a small management unit to improve the wide-area random write performance
When the access frequency from a host is low, an operation is performed by using a large management unit and a small management unit to improve the read performance and a narrow-area random write performance

Moreover, management information in small management units for the whole data in an SSD is included in a nonvolatile semiconductor memory. This management information in small management units may be cached in the management information storage buffer.

Furthermore, when the access frequency from a host is low, fragmented data in small management units is rearranged as data in large management units to return to a management structure of performing control by combining two management units, i.e., a large management unit and a small management unit.

Exemplary embodiments of the present invention are explained below with reference to the drawings. In the following explanation, components having the same functions and configurations are denoted by the same reference numerals and signs, and overlapping explanation is made only when necessary.

First, terms used in the specification are defined.
Page: A unit that can be collectively written and read out in a NAND-type flash memory.
Block: A unit that can be collectively erased in a NAND-type flash memory. A block includes a plurality of pages.
Sector: A minimum access unit from a host. A sector size is, for example, 512 B.
Cluster: A management unit for managing “small data” in an SSD. A cluster size is set such that a size of natural number times of a sector size is the cluster size.
Track: A management unit for managing “large data” in an SSD. A track size is set such that a size twice or larger natural number times as large as the cluster size is the track size.
Free block (FB): A block which does not include valid data therein and to which a use is not allocated.
Active block (AB): A block that includes valid data therein.
Valid cluster: Latest data of the cluster size corresponding to a logical address.
Invalid cluster: Data of the cluster size that is not to be referred to as a result that latest data having an identical logical address is written in a different location.
Valid track: Latest data of the track size corresponding to a logical address.
Invalid track: Data of the track size that is not to be referred to as a result that latest data having an identical logical address is written in a different location.
Compaction: Organizing of data that does not include conversion of a management unit.
Defragmentation (defrag): Organizing of data including conversion of a management unit from a cluster to a track.
Cluster merge (decomposition of a track): Organizing of data including conversion of a management unit from a track to a cluster.

Each functional block illustrated in the following embodiments can be realized as any one of or a combination of hardware and software. Therefore, each functional block is explained below generally in terms of the functions thereof for clarifying that each functional block is any of these. Whether such functions are realized as hardware or software depends on a specific embodiment or a design constraint imposed on the whole system. One skilled in the art can realize these functions by various methods in each specific embodiment, and determination of such realization is within the scope of the present invention.

### First Embodiment

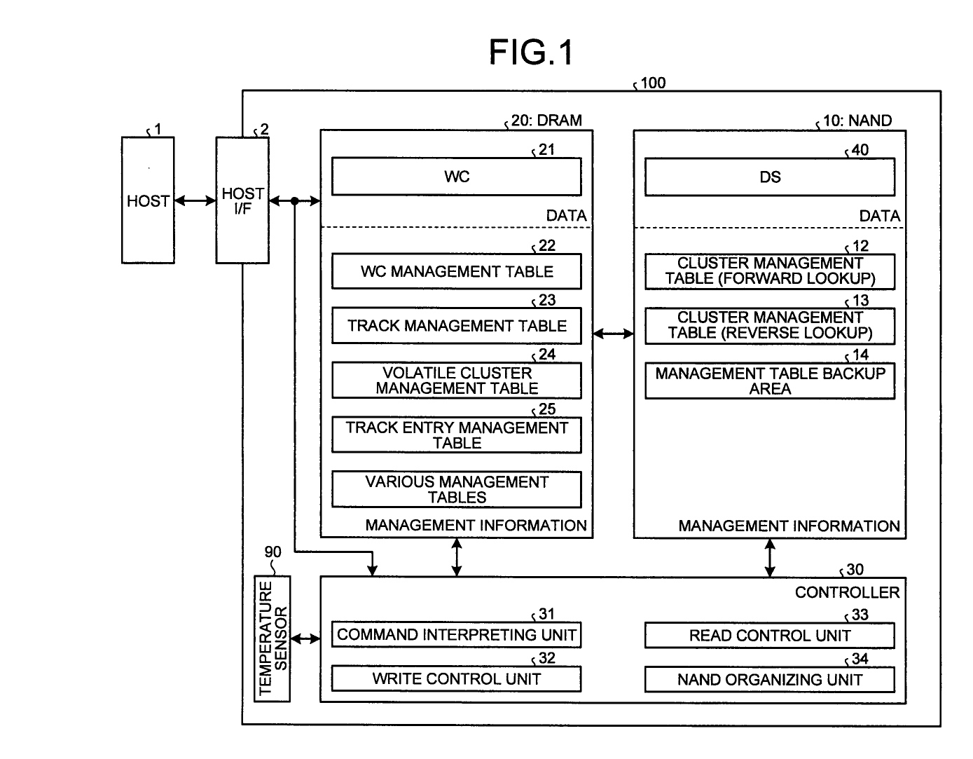

FIG. 1 is a functional block diagram illustrating a configuration example of an SSD 100 according to the first embodiment. The SSD 100 is connected to a host apparatus (hereinafter, abbreviated as host) 1 such as a PC via a host interface (host I/F) 2 such as an ATA interface (ATA I/F) and functions as an external memory of the host 1. As the host 1, a CPU of a PC, a CPU of an imaging device such as a still camera and a video camera, and the like can be exemplified.

Moreover, the SSD 100 includes a NAND-type flash memory (hereinafter, abbreviated as NAND flash) 10 as a nonvolatile semiconductor memory, a DRAM 20 (Dynamic Random Access Memory) as a volatile semiconductor memory that is capable of high-speed storing operation and random access compared with the NAND flash 10 and does not need an erase operation, and a controller 30 that performs various controls related to data transfer between the NAND flash 10 and the host 1. The SSD 100 may be provided with a temperature sensor 90 that detects an ambient temperature.

As a volatile semiconductor memory, an SRAM (Static Random Access Memory), an FeRAM (Ferroelectric Random Access Memory), an MRAM (Magnetoresistive Random Access Memory), a PRAM (Phase Change Random Access Memory), or the like can be used other than the DRAM 20. The volatile semiconductor memory may be mounted on the controller 30. When the capacity of the volatile semiconductor memory mounted on the controller 30 is large, data and the management information to be described later may be stored in the volatile semiconductor memory in the controller 30 and a volatile semiconductor memory may not be additionally provided outside the controller 30.

The NAND flash 10, for example, stores user data specified by the host 1, stores management tables that manage user data, and stores the management information managed in the DRAM 20 for backup. In a data storage (hereinafter, DS) 40 configuring a data area of the NAND flash 10, user data is stored. In a management table backup area 14, the management information managed in the DRAM 20 is backed up.

A forward-lookup nonvolatile cluster management table 12 (hereinafter, abbreviated as forward-lookup cluster management table) and a reverse-lookup nonvolatile cluster management table 13 (hereinafter, abbreviated as reverse-lookup cluster management table) are managed in the NAND flash 10. Details of the management tables are described later. The data area and the management area are distinguished in the NAND flash 10 for convenience' sake, however, this does not mean that blocks used in these areas are fixed.

The NAND flash 10 includes a memory cell array in which a plurality of memory cells is arrayed in a matrix manner, and each memory cell can perform multi-value storage by using an upper page and a lower page. The NAND flash 10 includes a plurality of memory chips and each memory chip is formed by arranging a plurality of blocks as a unit of data erasing. Moreover, in the NAND flash 10, data writing and data reading are performed for each page. A block includes a plurality of pages. Overwriting in the same page needs to be performed after once performing erasing on the whole block including the page. A block may be selected from each of a plurality of chips that form the NAND flash 10 and can operate in parallel and these blocks may be combined to be set as a collective erase unit. In the similar manner, a page may be selected from each of a plurality of chips that form the NAND flash 10 and can operate in parallel and these pages may be combined to be set as a collective write or collective read unit.

The DRAM 20 includes a write cache (hereinafter, WC) 21 that functions as a data transfer cache between the host 1 and the NAND flash 10. Moreover, the DRAM 20 functions as a management information storage memory and a work area memory. A management information storage table managed in the DRAM 20 includes a WC management table 22, a track management table 23, a volatile cluster management table 24, a track entry management table 25, and other various management tables. Details of the management tables are described later. The management tables managed in the DRAM 20 are generated by loading various management tables (management tables excluding the forward-lookup cluster management table 12 and the reverse-lookup cluster management table 13) stored in the NAND flash 10 at the time of start-up or the like and are saved in the management table backup area 14 of the NAND flash 10 at the time of power-off.

Both the data transfer cache area and the management information storage memory and the work area memory do not need to be formed in the same DRAM 20. The data transfer cache area may be formed in a first DRAM and the management information storage memory and the work area memory may be formed in a second DRAM different from the first DRAM. Moreover, they may be formed in different types of volatile memories. For example, the data transfer cache may be formed in a DRAM outside the controller and the management information storage memory and the work area memory may be formed in an SRAM in the controller. Furthermore, the DRAM 20 may include a read cache (hereinafter, RC) that functions as the data transfer cache between the host 1 and the NAND flash 10. Moreover, in the present embodiment, explanation is given as a write cache and a read cache, however, it is possible to employ a simple data buffer that temporarily holds write data or read data without using a cache algorithm.

The function of the controller 30 is realized by a processor that executes a system program (firmware) stored in the NAND flash 10, various hardware circuits, and the like, and performs a data transfer control between the host 1 and the NAND flash 10 with respect to various commands, such as a write request, a cache flush request, and a read request from the host 1, update and management of various management tables stored in the DRAM 20 and the NAND flash 10, and the like. The controller 30 includes a command interpreting unit 31, a write control unit 32, a read control unit 33, and a NAND organizing unit 34. The function of each component is described later. As a hardware circuit of the controller 30, for example, a ROM (Read Only Memory) that stores a boot loader, a RAM (Random Access Memory) for loading a firmware, and an error detection and correction circuit are included.

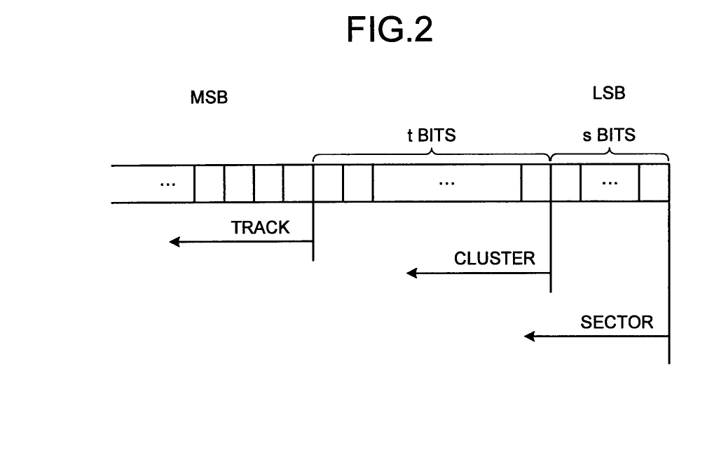

When issuing a read request or a write request to the SSD 100, the host 1 inputs LBA (Logical Block Addressing) as a logical address via the host I/F 2. As shown in FIG. 2, LBA is a logical address in which serial numbers from zero are attached to sectors (size: for example, 512 B). In the present embodiment, as the management unit for the WC 21 and the NAND flash 10, a cluster address formed of a bit string equal to or higher in order than a low-order (s+1)th bit of LBA and a track address formed of a bit string equal to or higher in order than a low-order (s+t+1)th bit of LBA are defined. In the following explanation, one block is formed of four track data, one track is formed of eight cluster data, and therefore one block is formed of 32 cluster data, however, these relationships are arbitrary.

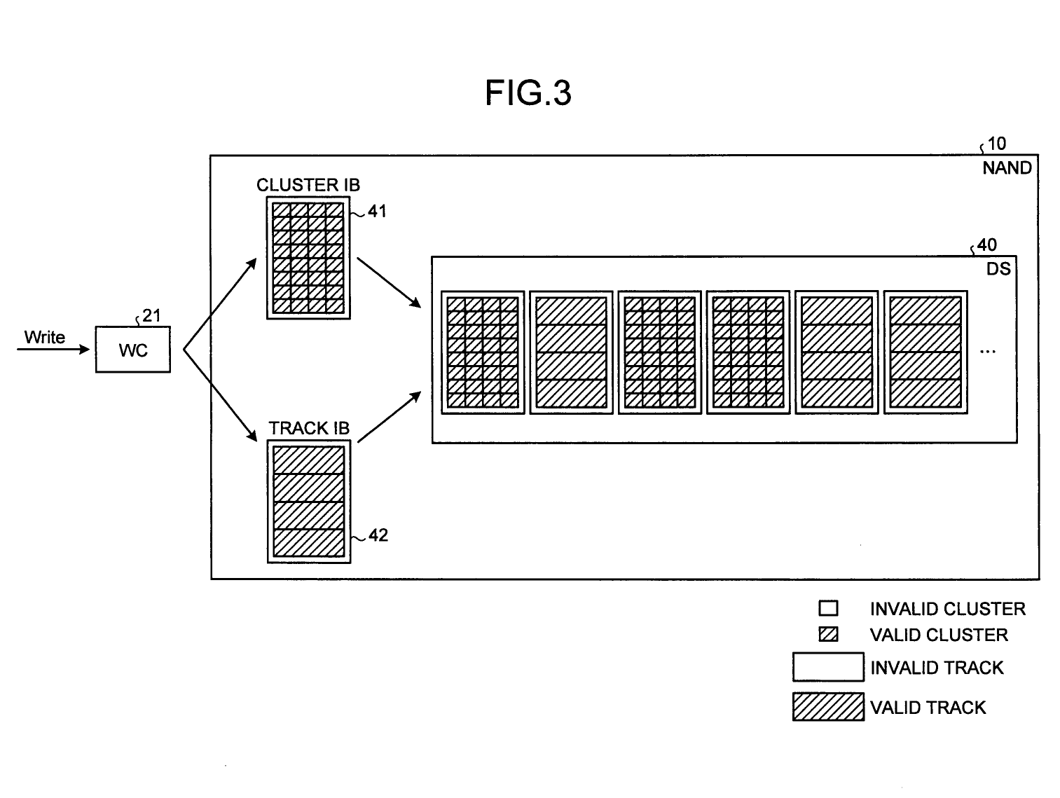

FIG. 3 illustrates functional blocks of the data area formed in the NAND flash 10. The write cache (WC) 21 formed in the DRAM 20 is interposed between the host 1 and the NAND flash 10. A read cache may be formed in the DRAM 20. The WC 21 temporarily stores data input from the host 1.

Blocks in the NAND flash 10 are allocated to the management areas, i.e., an input buffer area for cluster (cluster IB) 41, an input buffer area for track (track IB) 42, and the data storage (DS) 40 by the controller 30. 32 cluster data can be stored in 1 block forming the cluster IB 41 and 4 track data can be stored in 1 block forming the track IB 42. The cluster IB 41 and the track IB 42 each may be formed of a plurality of blocks.

When flushing data from the WC 21 to the NAND flash 10, the data is flushed to the cluster IB 41 in the case of flushing in cluster units that are “small units” and the data is flushed to the track IB 42 in the case of flushing in track units that are “large units”. The switching rule of the management unit of whether data is flushed in cluster units or track units is described later. The cluster IB 41 that becomes full of cluster data or the track IB 42 that becomes full of track data is thereafter managed as a block of the DS 40 to be moved to the DS 40.

Write Cache (WC) 21

The WC 21 is an area for temporarily storing, in response to a write request from the host 1, data input from the host 1. Data in the WC 21 is managed in sector units. When the resource of the WC 21 becomes insufficient, data stored in the WC 21 is flushed to the NAND flash 10. In this flushing, the data present in the WC 21 is flushed to any one of the cluster IB 41 and the track IB 42 according to a predetermined flushing rule.

As the flushing rule, for example, it is sufficient that sector data as a flush target from the WC 21 is selected so that old data is first selected based on a reference such as an LRU (Least Recently Used). As the switching rule of the management unit, for example, a rule is employed in which when an update data amount (valid data amount) in a track including sector data as a flush target present in the WC 21 is equal to or more than a threshold, the data is flushed to the track IB 42 as track data, and when an update data amount in a track including sector data as a flush target present in the WC 21 is less than the threshold, the data is flushed to the cluster IB 41 as cluster data.

In the case where not all data is collected in the WC 21 when flushing data from the WC 21 as cluster data, it is determined whether there is valid sector data included in the same cluster in the NAND flash 10. When the valid sector data is present, the sector data in the NAND flash 10 is padded in the cluster data in the WC 21 in the DRAM 20 and the padded cluster data is flushed to the cluster IB 41.

In the case where not all data is collected in the WC 21 when flushing data from the WC 21 as track data, it is determined whether there is valid cluster data or valid sector data included in the same track in the NAND flash 10. When the valid cluster data or sector data is present, the cluster data or the sector data in the NAND flash 10 is padded in the track data in the WC 21 in the DRAM 20 and the padded track data is flushed to the track IB 42.

Data Storage Area (DS) 40

In the DS 40, data is managed in track units and cluster units and user data is stored. A track whose LBA is the same as a track input to the DS 40 is invalidated in a block of the DS 40 and a block in which all tracks are invalidated in the block is released as the free block FB. A cluster whose LBA is the same as a cluster input to the DS 40 is invalidated in a block of the DS 40 and a block in which all clusters are invalidated in the block is released as the free block FB. Freshness of blocks in the DS 40 is managed in a writing order (LRU) of data, in other words, in order in which data is moved to the DS 40 from the cluster IB 41 or the track IB 42. Moreover, blocks in the DS 40 are managed also in order of magnitude of the number of valid data (for example, the number of valid clusters) in a block.

In the DS 40, the data organizing is performed. When the condition for the data organizing is satisfied, the data organizing including the compaction, the defragmentation, and the like is performed. The compaction is the data organizing without including conversion of the management unit and includes a cluster compaction of collecting valid clusters and rewriting them in one block as clusters and a track compaction of collecting valid tracks and rewriting them in one block as tracks. The defragmentation is the data organizing including conversion of the management unit from a cluster to a track, and collects valid clusters, arranges the collected valid clusters in order of LBA to integrate them into a track, and rewrites it in one block. The cluster merge is so called decomposition of a track and is the data organizing including conversion of the management unit from a track to a cluster, and collects valid clusters in a track and rewrites them in one block. The data organizing is described in detail later.

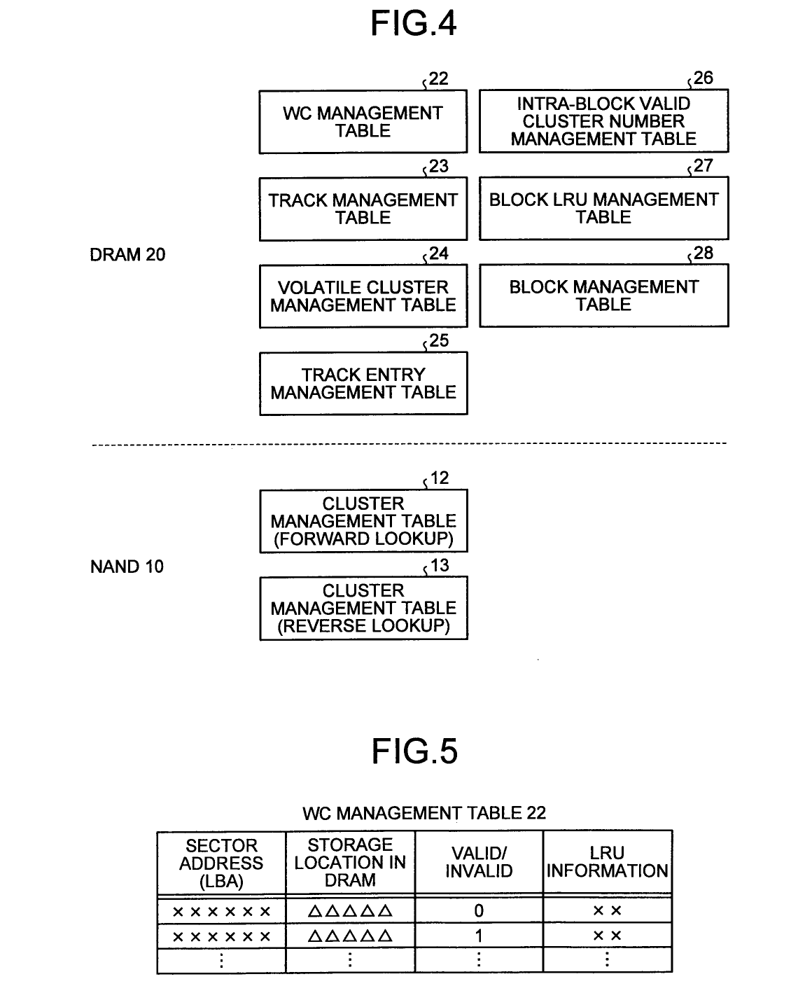

FIG. 4 illustrates the management tables for managing the WC 21 and the DS 40 by the controller 30 and also illustrates whether the management tables including the latest management information are present in the DRAM 20 or the NAND flash 10. In the DRAM 20, the WC management table 22, the track management table 23, the volatile cluster management table 24, the track entry management table 25, an intra-block valid cluster number management table 26, a block LRU management table 27, a block management table 28, and the like are included. In the NAND flash 10, the forward-lookup cluster management table 12 and the reverse-lookup cluster management table 13 are included.

WC Management Table 22

FIG. 5 illustrates an example of the WC management table 22. The WC management table 22 is stored in the DRAM 20 and manages data stored in the WC 21 in sector address units of LBA. In each entry of the WC management table 22, a sector address of LBA corresponding to data stored in the WC 21, a physical address indicating a storage location in the DRAM 20, and a sector flag indicating whether the sector is valid or invalid are associated with each other. Valid data indicates the latest data and invalid data indicates data that is not to be referred to as a result that data having an identical logical address is written in a different location. When flushing from the WC 21 to the NAND flash 10, in the case where the flushing order is determined with reference to the LRU, LRU information indicating the order of freshness of the update time between sectors may be registered for each sector address. Moreover, the WC management table 22 may be managed in cluster units or track units. When managing in cluster units or track units, the LRU information (for example, data update time order in the WC 21) in the WC 21 between clusters or tracks may be managed.

Track Management Table 23

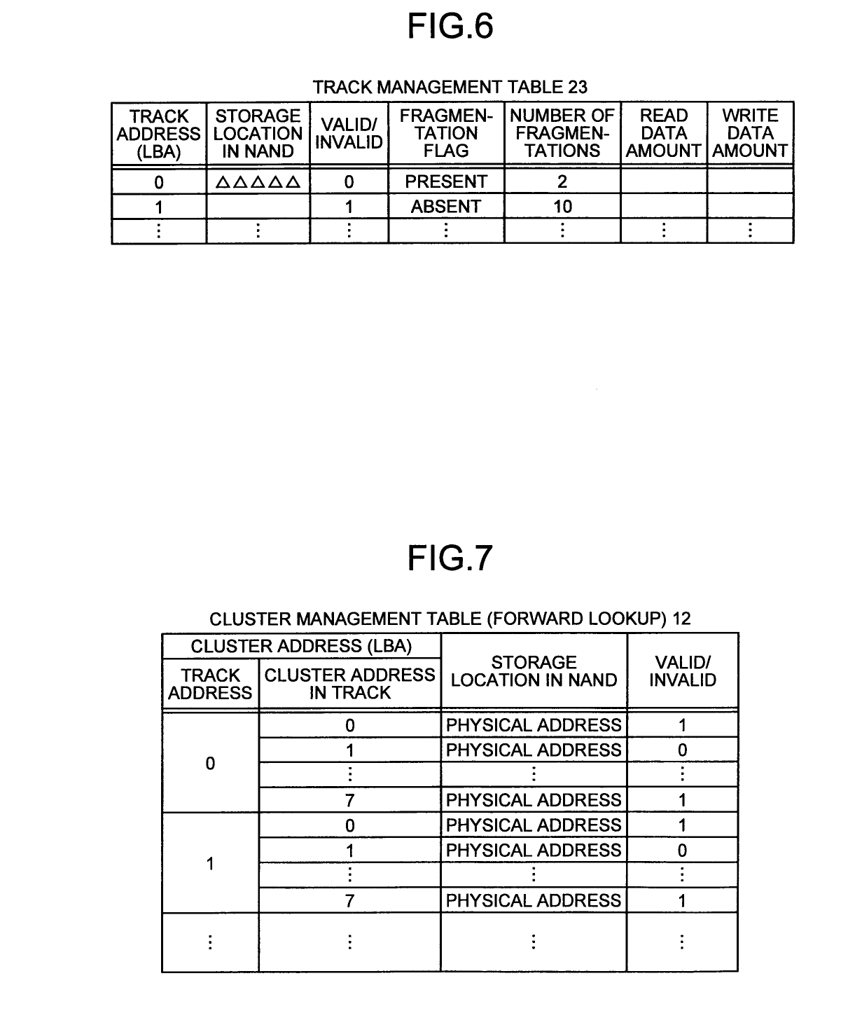

FIG. 6 illustrates an example of the track management table 23. The track management table 23 is stored in the DRAM 20 and is a table for obtaining track information from a track address of LBA. The track information includes a storage location (a block number and an intra-block storage location in which track data is stored) in the NAND flash 10 in which track data is stored, a track valid/invalid flag indicating whether the track is valid or invalid, and a fragmentation flag indicating whether fragmented cluster data is present in the track, which are associated with each other.

Fragmented cluster data is, for example, the latest cluster data that is present in a block different from a block in which track data is stored and is included in the track. In other words, fragmented cluster data indicates updated cluster data in a track in the NAND flash 10. When the fragmentation flag indicates that a fragmented cluster is not present, this indicates that an address can be resolved only by the track management table 23 (needless to say, in the forward-lookup cluster management table 12, the management information in cluster management units for all of the data in the SSD is included, so that an address can be resolved also by using the forward-lookup cluster management table 12), however, when the fragmentation flag indicates that a fragmented cluster is present, this indicates that an address cannot be resolved only by the track management table 23 and the volatile cluster management table 24 or the forward-lookup cluster management table 12 further needs to be searched.

In the track management table 23, as shown in FIG. 6, the number of fragmentations (the number of fragmented clusters) may be managed as fragmentation information. Moreover, in the track management table 23, a read data amount for each track and a write data amount for each track may be managed. The read data amount of a track indicates the total read data amount of data (sector, cluster, and track) included in the track and is used for determining whether the track is read-accessed frequently. It is possible to use the number of times of reading (total number of times of reading of data (sector, cluster, and track) included in a track) of a track instead of the read data amount of a track.

The write data amount of a track indicates the total write data amount of data (sector, cluster, and track) included in a track and is used for determining whether the track is write-accessed frequently. It is possible to use the number of times of writing (total number of times of writing of data (sector, cluster, and track) included in a track) of a track instead of the write data amount of a track.

Forward-Lookup Cluster Management Table 12

FIG. 7 illustrates an example of the forward-lookup cluster management table 12. The forward-lookup cluster management table 12 is stored in the NAND flash 10. A forward lookup table is a table for searching for a storage location in the NAND flash 10 from a logical address (LBA). On the contrary, a reverse lookup table is a table for searching for a logical address (LBA) from a storage location in the NAND flash 10.

The forward-lookup cluster management table 12 is a table for obtaining cluster information from a cluster address of LBA. The forward-lookup cluster management table 12 includes the management information in cluster units for the full capacity of the DS 40 of the NAND flash 10. Cluster addresses are collected in track units. In the present embodiment, one track includes eight clusters, so that entries for eight cluster information are included in one track. The cluster information includes a storage location (a block number and an intra-block storage location in which cluster data is stored) in the NAND flash 10 in which cluster data is stored and a cluster valid/invalid flag indicating whether the cluster is valid or invalid, which are associated with each other.

In the forward-lookup cluster management table 12, the management information in each track unit may be stored in a distributed fashion in a plurality of blocks so long as the management information in one track unit is collectively stored in the same block. In this case, storage locations in the NAND flash 10 of the management information in track units are managed by the track entry management table 25 to be described later. Moreover, this forward-lookup cluster management table 12 is used for read processing and the like.

Volatile Cluster Management Table 24

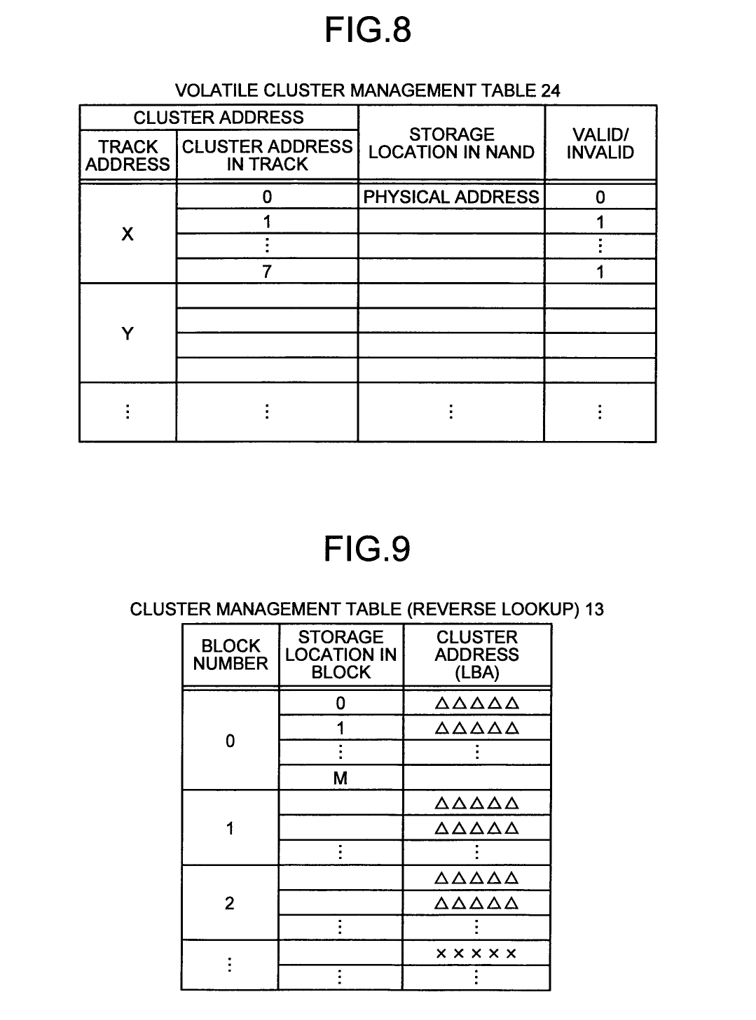

FIG. 8 illustrates an example of the volatile cluster management table 24. The volatile cluster management table 24 is a table obtained by caching part of the forward-lookup cluster management table 12 stored in the NAND flash 10 in the DRAM 20. Therefore, the volatile cluster management table 24 is also collected in track units in the similar manner to the forward-lookup cluster management table 12 and includes a storage location (a block number and an intra-block storage location in which cluster data is stored) in the NAND flash 10 in which cluster data is stored and a cluster valid/invalid flag indicating whether the cluster is valid or invalid for each entry of a cluster address.

The resource usage of the volatile cluster management table 24 in the DRAM 20 increases and decreases. At the time immediately after the SSD 100 is activated, the resource usage of the volatile cluster management table 24 in the DRAM 20 is zero. When reading out cluster data from the NAND flash 10, the forward-lookup cluster management table 12 in a track unit corresponding to a track including a cluster to be read out is cached in the DRAM 20. Moreover, when writing cluster data to the NAND flash 10, if the volatile cluster management table 24 corresponding to a cluster to be written is not cached in the DRAM 20, the forward-lookup cluster management table 12 in a track unit corresponding to a track including the cluster to be written is cached in the DRAM 20, the volatile cluster management table 24 in the DRAM 20 cached according to the write contents is updated, and furthermore the updated volatile cluster management table 24 is written in the NAND flash 10 to make the table nonvolatile. In this manner, according to reading or writing with respect to the NAND flash 10, the resource usage of the volatile cluster management table 24 in the DRAM 20 changes within a range of an allowable value.

The controller 30 updates and manages the management tables in the priority order of the volatile cluster management table 24→the forward-lookup cluster management table 12→the track management table 23, and this order can be deemed as the priority order of reliability of information for resolving an address.

Reverse-Lookup Cluster Management Table 13

FIG. 9 illustrates an example of the reverse-lookup cluster management table 13. The reverse-lookup cluster management table 13 is stored in the NAND flash 10. The reverse-lookup cluster management table 13 is a table for searching for a cluster address of LBA from a storage location in the NAND flash 10 and is, for example, collected in block number units. Specifically, a storage location in the NAND flash 10 specified from a block number and an intra-block storage location (for example, page number) is associated with a cluster address of LBA. This reverse-lookup cluster management table 13 is used for the organizing of the NAND flash 10 and the like. Part of the reverse-lookup cluster management table 13 may be cached in the DRAM 20. In the similar manner to the forward-lookup cluster management table 12, the reverse-lookup cluster management table 13 also includes the management information in cluster units for the full capacity of the DS 40 of the NAND flash 10.

Track Entry Management Table 25

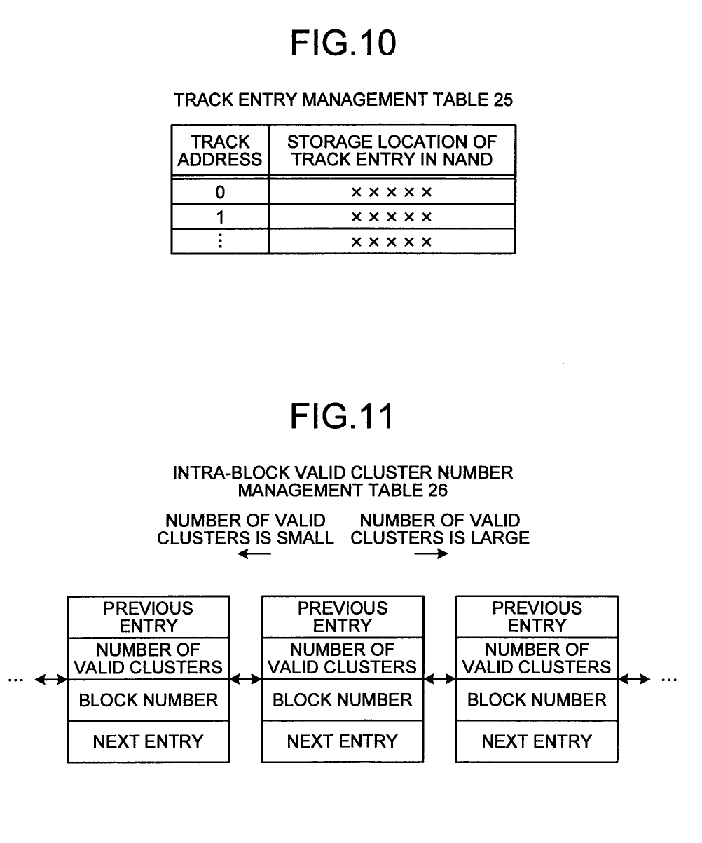

FIG. 10 illustrates an example of the track entry management table 25. The track entry management table 25 is stored in the DRAM 20. The track entry management table 25 is a table for specifying a storage location in the NAND flash 10 of each track entry (in this embodiment, one track entry is formed of eight cluster entries) collected in a track address unit of the forward-lookup cluster management table 12. The track entry management table 25 is, for example, associated with pointer information for specifying a storage location in the NAND flash 10 of a track entry for each track address. A plurality of track entries may be collectively specified by one pointer information. Moreover, it is possible to have the pointer information in cluster address units.

Intra-Block Valid Cluster Number Management Table 26

FIG. 11 illustrates an example of the intra-block valid cluster number management table 26. The intra-block valid cluster number management table 26 is stored in the DRAM 20. The intra-block valid cluster number management table 26 is a table that manages the number of valid clusters in a block for each block and, in FIG. 11, manages information, each including the number of valid clusters in one block, with each other in ascending order of the number of valid clusters in a block as a bidirectional list. In one entry of the list, pointer information to a previous entry, the number of valid clusters (or valid cluster rate), a block number, and pointer information to the next entry are included. The main purpose of the intra-block valid cluster number management table 26 is the organizing of the NAND flash 10 and the controller 30 selects an organizing target block based on the number of valid clusters.

Block LRU Management Table 27

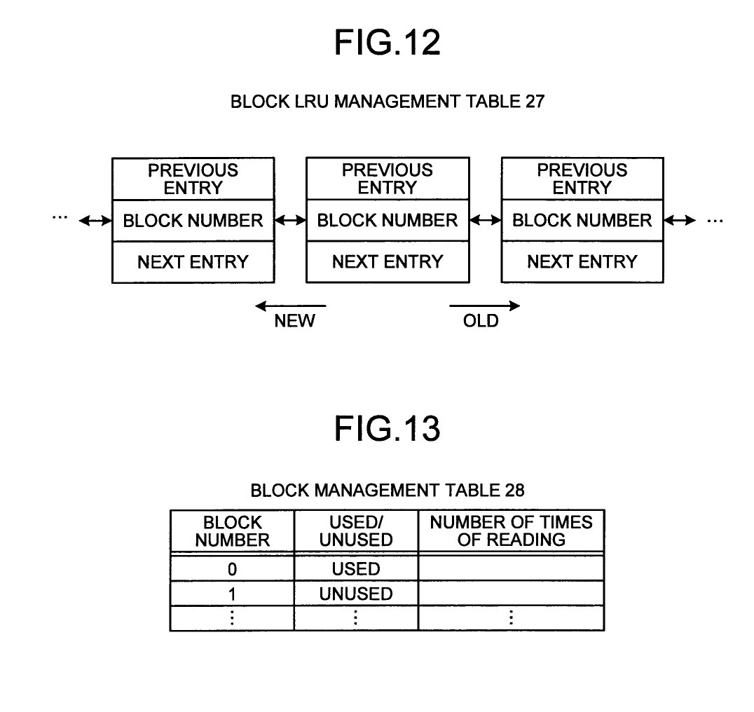

FIG. 12 illustrates an example of the block LRU management table 27. The block LRU management table 27 is stored in the DRAM 20. The block LRU management table 27 is a table that manages the order of freshness (LRU: Least Recently used) at the time when writing is performed on a block for each block and, in FIG. 12, manages information, each including a block number of one block, with each other in LRU order as a bidirectional list. The point of time of writing managed in the block LRU management table 27 is, for example, a point of time at which the free block FB is changed to the active block AB. In one entry of the list, pointer information to a previous entry, a block number, and pointer information to the next entry are included. The main purpose of the block LRU management table 27 is the organizing of the NAND flash 10 and the controller 30 selects an organizing target block based on the order of freshness of blocks.

Block Management Table 28

FIG. 13 illustrates an example of the block management table 28. The block management table 28 identifies and manages whether each block is in use, that is, whether each block is the free block FB or the active block AB. The free block FB is an unused block in which valid data is not included and to which a use is not allocated. The active block AB is a block in use in which valid data is included and to which a use is allocated. With the use of this block management table 28, the free block FB to be used in writing with respect to the NAND flash 10 is selected. An unused block includes both a block on which writing has never been performed and a block on which writing is performed once and in which, subsequently, all data becomes invalid data. As described above, a prior erase operation is needed for overwriting in the same page, so that erasing is performed on the free block FB at a predetermined timing before being used as the active block AB.

In the block management table 28, the number of times of reading for each block may be managed for identifying a block that is read-accessed frequently. The number of times of reading of a block is the total number of times of occurrence of a read request for data in a block and is used for determining a block that is read-accessed frequently. A read data amount (total amount of data read out from a block) in a block may be used instead of the number of times of reading.

In the SSD 100, the relationship between a logical address (LBA) and a physical address (storage location in the NAND flash 10) is not statically determined in advance and a logical-to-physical translation system in which they are dynamically associated at the time of writing of data is employed. For example, when overwriting data of the same LBA, the following operation is performed. Assume that valid data of a block size is stored in a logical address A1 and a block B1 is used as a storage area. When a command for overwriting update data of the block size of the logical address A1 is received from the host 1, one free block FB (referred to as a block B2) is ensured and the data received from the host 1 is written in the free block FB. Thereafter, the logical address A1 is associated with the block B2. Consequently, the block B2 becomes the active block AB and the data stored in the block B1 becomes invalid, so that the block B1 becomes the free block FB.

In this manner, in the SSD 100, even for the data in the same logical address A1, a block to be actually used as a recording area changes every writing. A write destination block always changes in update data writing of a block size, however, update data is written in the same block in some cases in update data writing of less than a block size. For example, when cluster data that is less than a block size is updated, old cluster data of the same logical address in the block is invalidated and the latest cluster data, which is newly written, is managed as a valid cluster. When all data in a block is invalidated, the block is released as the free block FB.

With the management information managed in each of the above management tables, the controller 30 can associate a logical address (LBA) used in the host 1 with a physical address used in the SSD 100, so that data transfer between the host 1 and the NAND flash 10 can be performed.

As shown in FIG. 1, the controller 30 includes the command interpreting unit 31, the write control unit 32, the read control unit 33, and the NAND organizing unit 34. The command interpreting unit 31 analyzes a command from the host 1 and notifies the write control unit 32, the read control unit 33, and the NAND organizing unit 34 of the analysis result.

The write control unit 32 performs a WC write control of writing data input from the host 1 to the WC 21, a flush control of flushing data from the WC 21 to the NAND flash 10, and control relating to writing such as update of various management tables corresponding to the WC write control and the flush control.

The read control unit 33 performs a read control of reading out read data specified from the host 1 from the NAND flash 10 and transferring it to the host 1 via the DRAM 20 and control relating to reading such as update of various management tables corresponding to the read control.

The NAND organizing unit 34 performs the organizing (compaction, defragmentation, cluster merge, and the like) in the NAND flash 10. When the used resource amount (the resource usage) of the NAND flash 10 exceeds a threshold, the NAND organizing unit 34 performs the NAND organizing and thereby increases the free resource of the NAND flash 10. Therefore, the NAND organizing process may be called a NAND reclaiming process. The NAND organizing unit 34 may organize valid and invalid data and reclaim free blocks having no valid data.

The resource usage (for example, the resource usage of the volatile cluster management table 24) of the management table in the DRAM 20 may be employed as a trigger for the NAND organizing. The resource amount indicates the number of free blocks in which data in the NAND flash 10 is to be recorded, an amount of an area for the WC 21 in the DRAM 20, an amount of an unused area of the volatile cluster management table 24 in the DRAM 20, and the like, however, others may be managed as the resource.

Read Processing

Next, a summary of the read processing is explained. In the read processing, the WC management table 22, the volatile cluster management table 24, the track management table 23, and the forward-lookup cluster management table 12 are mainly used for address resolution. The priority order of reliability of information for the address resolution is follows.

(1) WC management table 22

(2) volatile cluster management table 24

(3) forward-lookup cluster management table 12

(4) track management table 23

However, in the present embodiment, table search is performed in the following order considering speed up of search.

(1) WC management table 22

(2) track management table 23

(3) volatile cluster management table 24

(4) forward-lookup cluster management table 12

Search of the volatile cluster management table 24 may be performed second and search of the track management table 23 may be performed third. Moreover, if a flag indicating whether there is data in the WC 21 is provided in the track management table 23, the search order of the tables can be changed such that search of the track management table 23 is performed first. In this manner, the search order of the management tables can be arbitrary set depending on the method of generating the management tables.

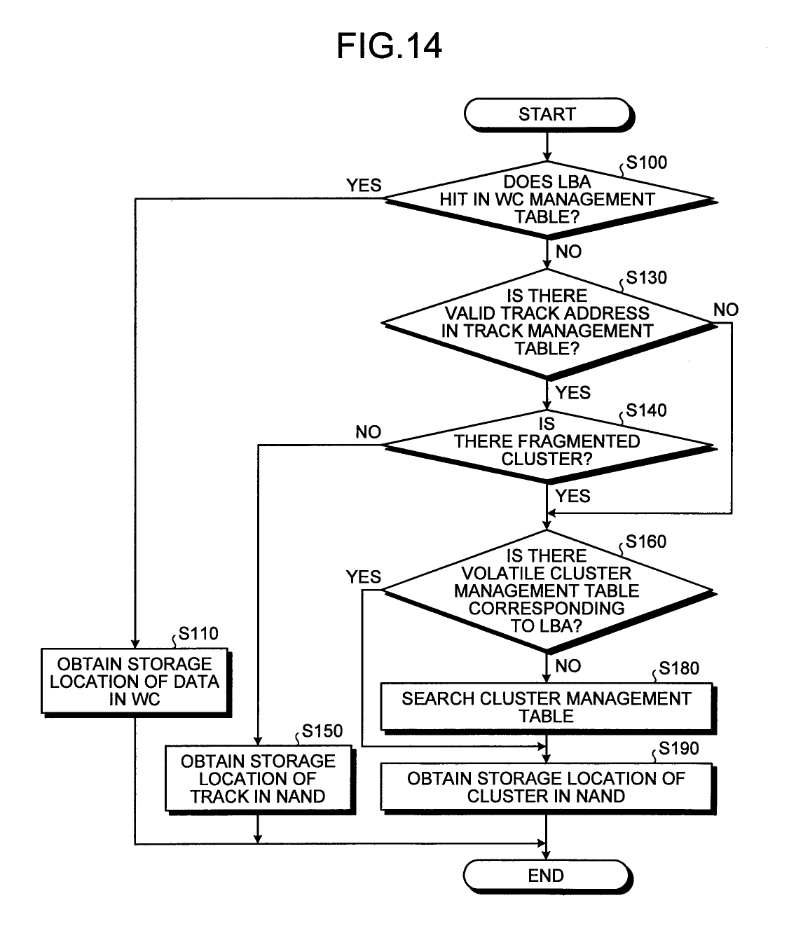

The forward-lookup address resolution procedure is explained with reference to FIG. 14. When a read command and LBA as a read address are input from the host 1 via the host I/F 2, the read control unit 33 searches whether there is data corresponding to the LBA in the WC 21 by searching the WC management table 22 (Step S100). When the LBA hits in the WC management table 22, the storage location in the WC 21 of the data corresponding to the LBA is obtained from the WC management table 22 (Step S110) and the data in the WC 21 corresponding to the LBA is read out by using the obtained storage location.

When the LBA does not hit in the WC 21, the read control unit 33 searches for the location in the NAND flash 10 where the data as a search target is stored. First, the track management table 23 is searched to determine whether there is a valid track entry corresponding to the LBA in the track management table 23 (Step S130). When there is no valid track entry, the procedure moves to Step S160. When there is a valid track entry, the fragmentation flag in the track entry is searched for to determine whether there is a fragmented cluster in the track (Step S140). When there is no fragmented cluster, the storage location in the NAND flash 10 of track data is obtained from the track entry (Step S150) and the data in the NAND flash 10 corresponding to the LBA is read out by using the obtained storage location.

When there is no valid track entry in the track management table 23 at Step S130 or when there is a fragmented cluster at Step S140, the read control unit 33 next searches the volatile cluster management table 24 to determine whether there is a valid cluster entry corresponding to the LBA in the volatile cluster management table 24 (Step S160). When there is the valid cluster entry corresponding to the LBA in the volatile cluster management table 24, the storage location in the NAND flash 10 of cluster data is obtained from the cluster entry (Step S190) and the data in the NAND flash 10 corresponding to the LBA is read out by using the obtained storage location.

At Step S160, when there is no cluster entry corresponding to the LBA in the volatile cluster management table 24, the read control unit 33 next searches the track entry management table 25 for searching the forward-lookup cluster management table 12. Specifically, the storage location in the NAND flash 10 of the cluster management table is obtained from the entry of the track entry management table 25 corresponding to the cluster address of the LBA, the track entry of the forward-lookup cluster management table 12 is read out from the NAND flash 10 by using the obtained storage location in the NAND flash 10, and the readout track entry is cached in the DRAM 20 as the volatile cluster management table 24. Then, the cluster entry corresponding to the LBA is extracted by using the cached forward-lookup cluster management table 12 (Step S180), the storage location in the NAND flash 10 of cluster data is obtained from the extracted cluster entry (Step S190), and the data in the NAND flash 10 corresponding to the LBA is read out by using the obtained storage location.

In this manner, data read out from the WC 21 or the NAND flash 10 by searching of the WC management table 22, the track management table 23, the volatile cluster management table 24, and the forward-lookup cluster management table 12 is integrated in the DRAM 20 as needed and is sent to the host 1.

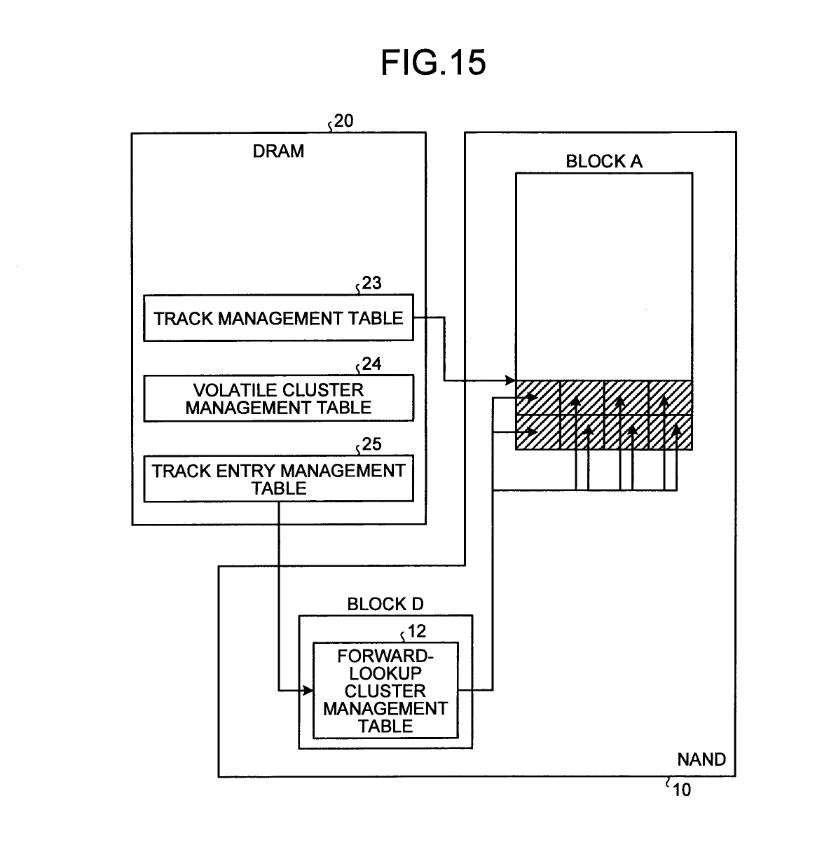

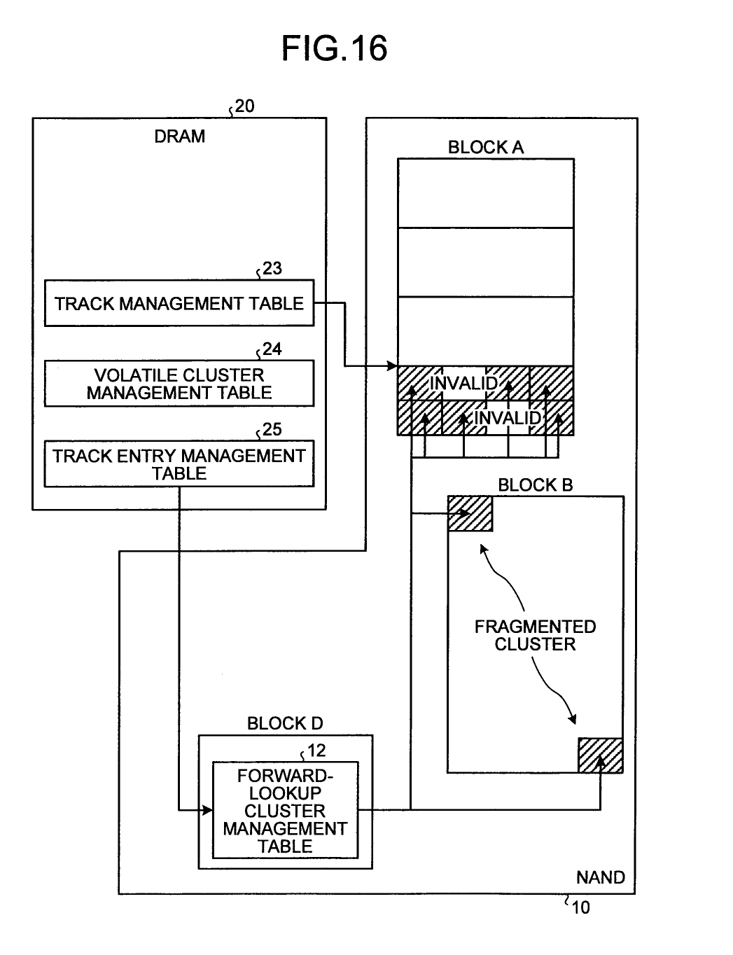

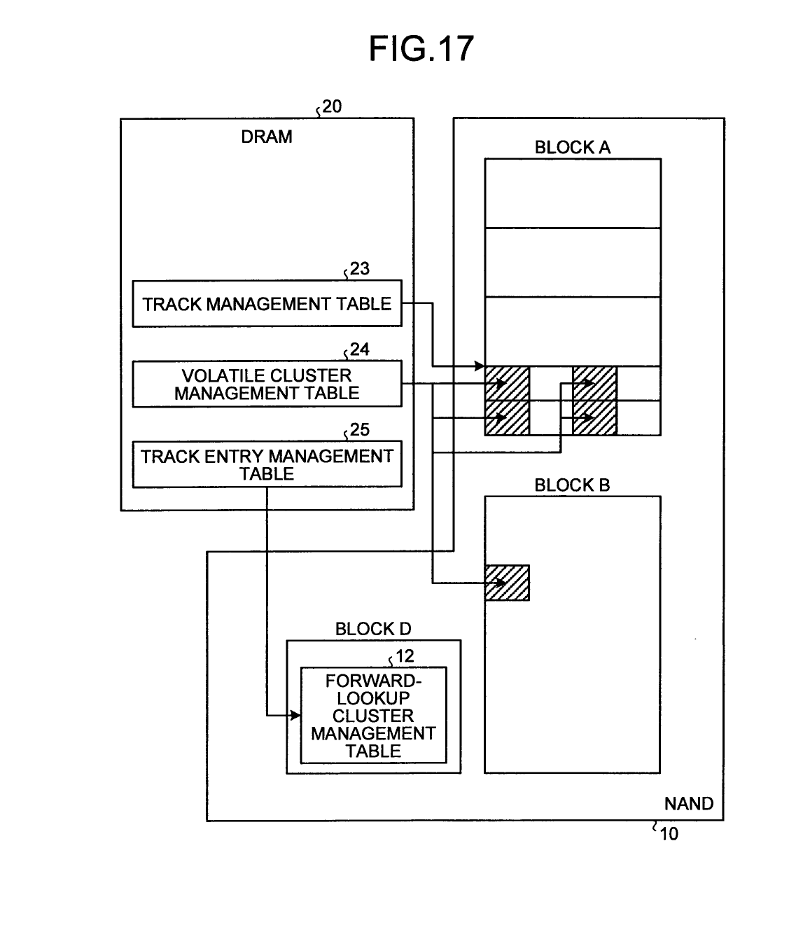

FIG. 15 is a diagram conceptually illustrating the above address resolution of data in the NAND flash 10. Track data managed in the track management table 23 and cluster data managed in the forward-lookup cluster management table 12 have a comprehensive relationship. FIG. 15 illustrates a case where a recorded location of a cluster of certain LBA can be resolved by any of the track management table 23 and the forward-lookup cluster management table 12. FIG. 16 illustrates a case where a recorded location of a cluster of certain LBA can be resolved only by the forward-lookup cluster management table 12. FIG. 17 illustrates a case where the latest recorded location can be resolved only by the volatile cluster management table 24 and the latest recorded location can be resolved also by the forward-lookup cluster management table 12 when information on the volatile cluster management table 24 is stored in the forward-lookup cluster management table 12.

Write Processing

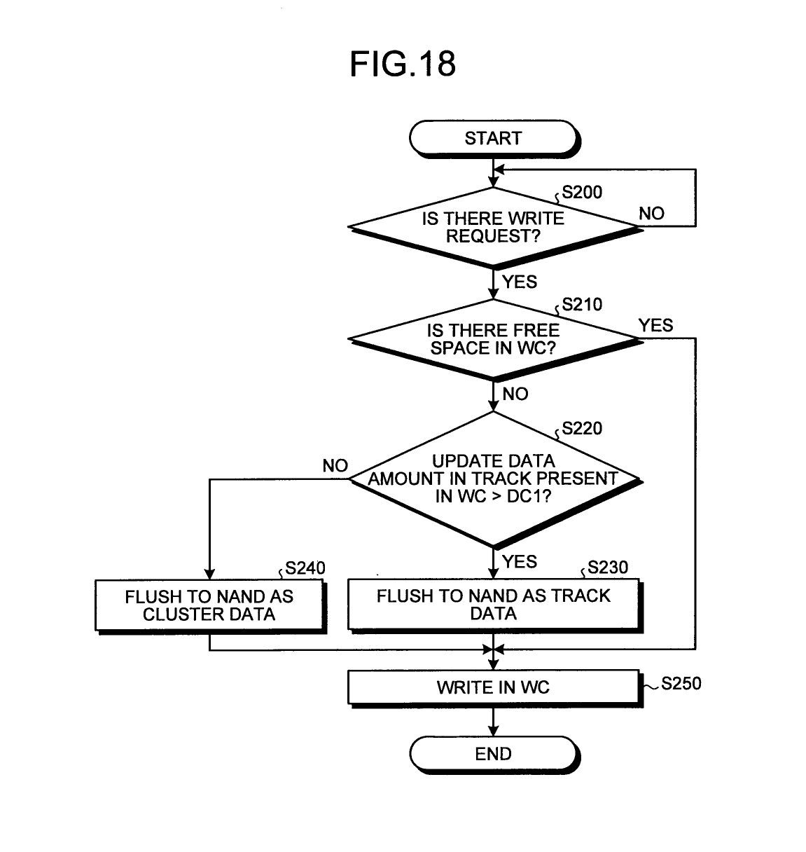

Next, a summary of the write processing is explained according to the flowchart show in FIG. 18. In the write processing, when a write command including LBA as a write address is input via the host I/F 2 (Step S200), the write control unit 32 writes the data specified by the LBA in the WC 21. Specifically, the write control unit 32 determines whether there is a free space according to the write request in the WC 21 (Step S210), and when there is a free space in the WC 21, the write control unit 32 writes the data specified by the LBA in the WC 21 (Step S250). The write control unit 32 updates the WC management table 22 along with this writing to the WC 21.

On the other hand, when there is no free space in the WC 21, the write control unit 32 flushes data from the WC 21 and writes the flushed data in the NAND flash 10 to generate a free space in the WC 21. Specifically, the write control unit 32 determines an update data amount in a track present in the WC 21 based on the WC management table 22. When the update data amount is equal to or more than a threshold DC1 (Step S220), the write control unit 32 flushes the data to the track IB 42 as track data (Step S230), and when the update data amount in the track present in the WC 21 is less than the threshold DC1, the write control unit 32 flushes the data to the cluster IB 41 as cluster data (Step S240). The update data amount in a track present in the WC 21 is a valid data amount in the same track present in the WC 21, and as for a track in which the valid data amount in the track is equal to or more than the threshold DC1, data is flushed to the track IB 42 as data of a track size and, as for a track in which the valid data amount in the track is less than the threshold DC1, data is flushed to the cluster IB 41 as data of a cluster size. For example, when the WC 21 is managed by a sector address, the total amount of valid sector data in the same track present in the WC 21 is compared with the threshold DC1 and the data is flushed to the track IB 42 or the cluster IB 41 according to this comparison result. Moreover, when the WC 21 is managed by a cluster address, the total amount of valid cluster data in the same track present in the WC 21 is compared with the threshold DC1 and the data is flushed to the track IB 42 or the cluster IB 41 according to this comparison result.

However, when flushing data from the WC 21, it is desired to follow the order rule of flushing old data first based on the LRU information in the WC management table 22. Moreover, when calculating the valid data amount in a track cached in the WC 21, the valid data amount in a track may be calculated each time by using a valid sector address in the WC management table 22 or it is applicable that the valid data amount in a track is calculated sequentially for each track to store it as the management information in the DRAM 20 and the valid data amount in a track is determined based on this stored management information. Moreover, when the WC management table 22 is managed in cluster units, the number of valid clusters in a track may be calculated each time by using the WC management table 22 or the number of valid clusters in a track may be stored as the management information for each track. Moreover, a valid data rate in a track may be used instead of the valid data amount in a track and a flush destination of data may be determined according to a comparison result of the valid data rate and a threshold.

As described above, when flushing data from the WC 21 as cluster data, if not all data is collected in the WC 21, it is determined whether there is valid sector data included in the same cluster in the NAND flash 10. When there is the valid sector data, the sector data in the NAND flash 10 is padded in the cluster data in the WC 21 in the DRAM 20 and the padded cluster data is flushed to the cluster IB 41. When flushing data from the WC 21 as track data, if not all data is collected in the WC 21, it is determined whether there is valid cluster data or valid sector data included in the same track in the NAND flash 10. When there is the valid cluster data or sector data, the cluster data or the sector data in the NAND flash 10 is padded in the track data in the WC 21 in the DRAM 20 and the padded track data is flushed to the track IB 42.

In this manner, after generating a free space in the WC 21, the write control unit 32 writes data specified by LBA in the WC 21 (Step S250). Moreover, the management table is updated according to data writing to the WC 21 and data flushing to the NAND flash 10. Specifically, the WC management table 22 is updated according to the update state of the WC 21.

When data is flushed to the NAND flash 10 as track data, the track management table 23 is updated, and the corresponding location in the forward-lookup cluster management table 12 is specified and read out by referring to the track entry management table 25 to be cached and updated in the DRAM 20 as the volatile cluster management table 24. Furthermore, after writing the updated table in the NAND flash 10, the track entry management table 25 is updated to point this write location. Moreover, the reverse-lookup cluster management table 13 is also updated.

On the other hand, when data is flushed to the NAND flash 10 as a cluster, the corresponding location of the forward-lookup cluster management table 12 is specified and read out by referring to the track entry management table 25 to be cached and updated in the DRAM 20 as the volatile cluster management table 24. Furthermore, after writing the updated table in the NAND flash 10, the track entry management table 25 is updated to point this write location. If the volatile cluster management table 24 is already present in the DRAM 20, reading of the forward-lookup cluster management table 12 in the NAND flash 10 is omitted.

Organizing of the NAND Flash

Next, the organizing of the NAND flash is explained. In the present embodiment, the contents of the organizing of the NAND flash are made different between when the access frequency from the host 1 is high and when the access frequency from the host 1 is low. The access frequency being high is, for example, a case where a reception interval of a command of a data transfer request from the host 1 is equal to or shorter than a threshold Tc, and the access frequency being low is a case where a reception interval of a command of a data transfer request from the host 1 is longer than the threshold Tc. The access frequency may be determined based on a data transfer rate from the host 1.

Regarding the data organizing when the access frequency is high,
the data organizing is started when the resource usage of the NAND flash 10 exceeds a limit value (for example, when the number of the free blocks FB becomes equal to or less than a limit value Flmt),
a block with less valid data amount (for example, the number of valid clusters) is selected as a data organizing target block, and
valid data of a data organizing target block is all managed in cluster units and the organizing (cluster merge and cluster compaction) is performed.

One of the characteristics of the present embodiment is that the cluster merge in which conversion of the management unit from a track unit to a cluster unit is performed is employed as the data organizing when the access frequency is high. Selection of a block with less valid data amount as a data organizing target block means to select in ascending order from a block with the least valid data amount. In the data organizing when the access frequency is high, a block in which the valid data amount is less than a threshold may be selected as a data organizing target block.

Regarding the data organizing when the access frequency is low,
the data organizing is started when the resource usage of the NAND flash 10 exceeds a target value (when the number of the free blocks FB becomes equal to or less than a target value Fref (>Flmt)),
a block with less valid data amount (for example, the number of valid clusters) is selected as a data organizing target block from among blocks whose write time is old, and
valid data of a data organizing target block is all managed in track units and the organizing (defragmentation and track compaction) is performed.

One of the characteristics of the present embodiment is that the defragmentation in which conversion of the management unit from a cluster to a track is performed is employed as the data organizing when the access frequency is low. In the data organizing when the access frequency is low, a block in which the valid data amount is less than a threshold among blocks whose write time is old may be selected as a data organizing target block.

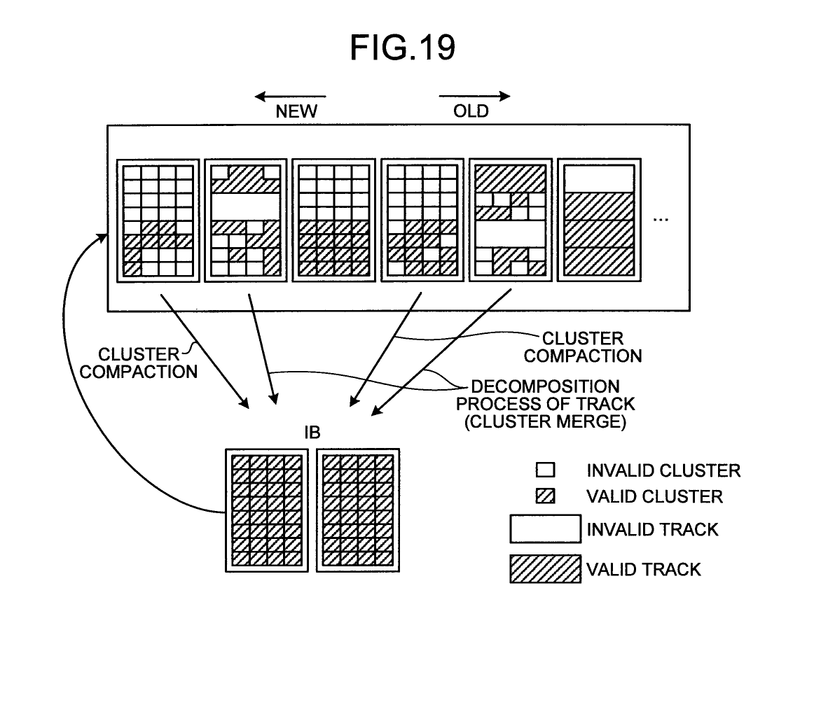

FIG. 19 is a diagram conceptually illustrating a state of one example of the data organizing when the access frequency is high. In the present embodiment, 4 track data or 32 cluster data can be accommodated in 1 block. In the storage capacity for one track, eight cluster data can be accommodated. Open squares indicate invalid data and hatched squares indicate valid data.

In the organizing when the access frequency is high, valid clusters from a block in which the number of valid clusters is small or valid clusters in a track are collected in the free block FB. The free block FB of a data collection destination is managed in cluster units and is controlled not to be managed in track units. As shown in FIG. 19, the data organizing when the access frequency is high, for example, includes the decomposition (cluster merge) of a track and the cluster compaction. The free block FB of a data collection destination is inserted as the active block AB into an entry (write time is the latest) of a list in which the LRU order is managed by the block LRU management table 27. A block in which valid data is no longer present by the data organizing is released as the free block FB.

In the decomposition (cluster merge) of a track, if the number of valid clusters in a track stored in a block is equal to or more than a threshold, it is possible to perform exception processing of directly copying data into the free block FB of a data collection destination as a track including an invalid cluster without performing the decomposition of a track and thereafter managing in track units. In other words, in the data organizing, the number of fragmentations of an organizing target track is obtained from the track management table 23 and the obtained number of fragmentations is compared with a threshold. When the number of fragmentations is less than the threshold, data is directly copied into the free block FB of a data collection destination without performing the decomposition of a track and the copied track is managed in track units thereafter. In this manner, clusters of a track in which the number of fragmentations is small are suppressed from being distributed by the decomposition of a track, thereby preventing decrease in the read performance.

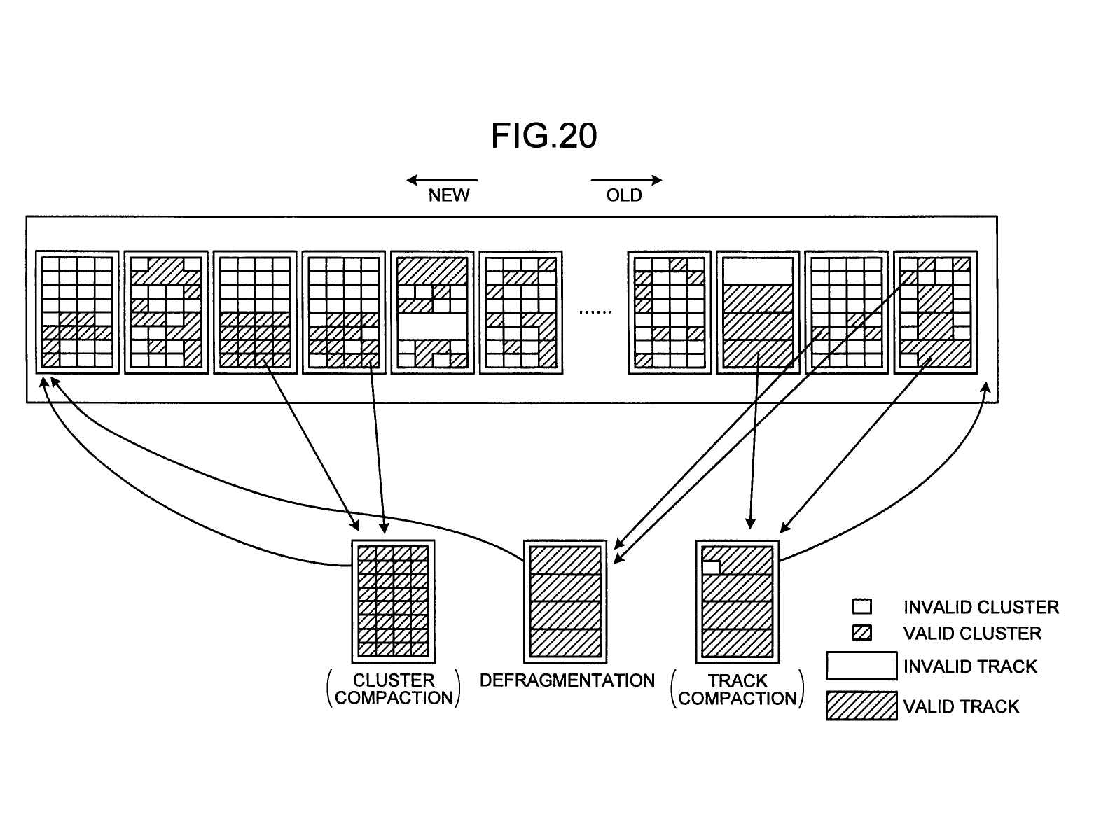

FIG. 20 is a diagram conceptually illustrating an example of the data organizing when the access frequency is low. In the organizing when the access frequency is low, the defragmentation is performed to rearrange a plurality of pieces of fragmented cluster data as track data in order of LBA, thereby returning to the management structure of performing control of the NAND flash 10 by combining two management units, i.e., a cluster unit and a track unit. When the access frequency is low, only the defragmentation may be performed, however, as shown in FIG. 20, the defragmentation, the track compaction, and moreover the cluster compaction may be performed concurrently. A block in which valid data is no longer present by the data organizing is released as the free block FB.

In FIG. 20, first, the track compaction is performed. In the track compaction, valid clusters in a block are checked and tracks, which a valid cluster belongs to and is managed as track data and whose a fragmented cluster rate is equal to or less than a predetermined rate, are collected in one free block FB. The fragmented cluster rate is calculated based on the number of fragmentations/the total number of clusters in a track by using the number of fragmentations in the track management table 23. It is needles to say that a track of a track compaction target may be selected by using the number of fragmentations instead of the fragmented cluster rate. The free block FB of a data collection destination is, for example, inserted as the active block AB into an exit side (write time is older) of a block in which compaction target data is present in a list in which the LRU order is managed by the block LRU management table 27.

In the following defragmentation, valid clusters that do not fall under the track compaction are integrated into track data to be collected in one free block FB. The free block FB of a data collection destination is inserted as the active block AB into an entry (write time is the latest) in a list in which the LRU order is managed by the block LRU management table 27.

Frequently rewritten data is expected to be collected on the entry side of a list in which the LRU order is managed by the block LRU management table 27, so that data on the exit side of a list, which is considered that the rewriting frequency is low, is preferentially formed into a track. By continuing this operation, infrequently rewritten track data is expected to be collected to the exit side of a list.

The cluster compaction is, for example, performed when the number of the free blocks FB becomes less than a threshold by the organizing of the NAND flash 10. Specifically, the number of the free blocks FB is likely to decrease by performing the defragmentation, so that the free blocks FB are increased by performing the cluster compaction. In the cluster compaction, for example, valid clusters that are not targeted for the above track compaction and defragmentation are collected in one free block FB. The free block FB of a data collection destination is inserted as the active block AB into an entry (write time is the latest) in a list in which the LRU order is managed by the block LRU management table 27. The number of the free blocks may be obtained also by calculating the number of the free blocks FB registered in the block management table 28 or the number of the free blocks may be stored as the management information.

In the data organizing, in the similar manner to the time of flushing from the WC 21, sector padding and cluster padding are performed as needed. That is, the sector padding is performed in the cluster merge and the cluster compaction and the sector padding and the cluster padding are performed in the defragmentation and the track compaction. When performing the data organizing excluding data in the WC 21, the sector padding can be omitted.

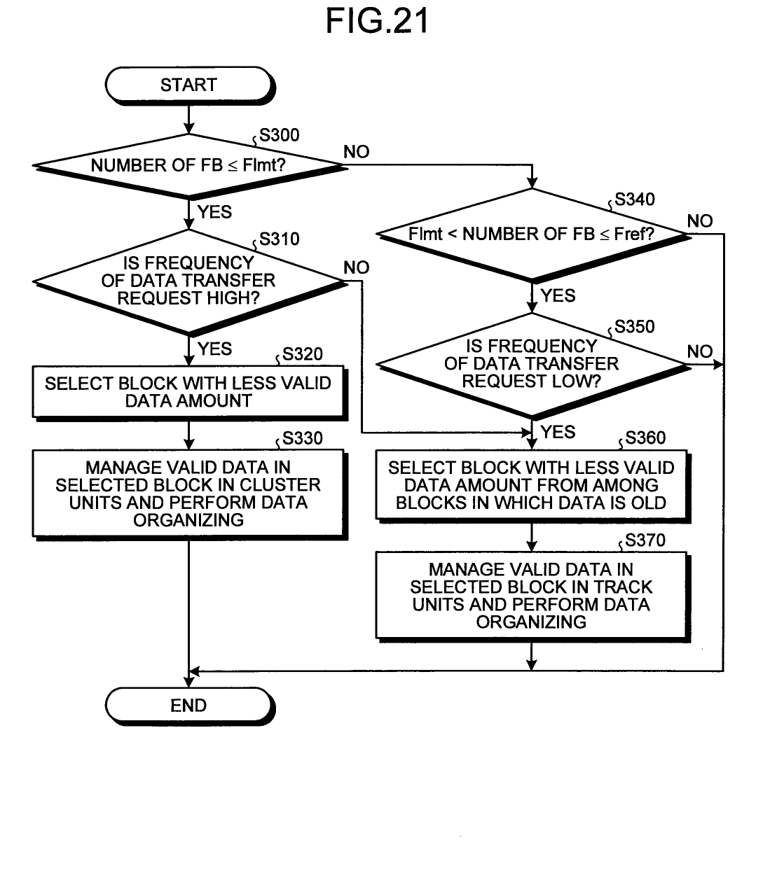

Next, the organizing of the NAND flash is explained in more detail according to the flowchart shown in FIG. 21. The NAND organizing unit 34 manages the number of the free blocks FB based on the block management table 28 (Step S300). When the number of the free blocks FB becomes equal to or less than the limit value Flmt, it is determined whether the access frequency is high by checking whether the interval of a data transfer request from the host 1 is shorter than a threshold (for example, 5 seconds) (Step S310), and when it is determined that the access frequency is high, a block with fewer number of valid clusters is selected as an organizing target block by referring to the intra-block valid cluster number management table 26 (Step S320).

Next, the NAND organizing unit 34 accesses the reverse-lookup cluster management table 13 from the block number of the organizing target block and obtains all of the addresses of the cluster data stored in the block. Then, the volatile cluster management table 24 and the forward-lookup cluster management table 12 are accessed from the obtained cluster addresses to determine whether the obtained clusters are valid, and only a valid cluster is set as cluster data of an organizing target. When the cluster data of the organizing target is determined, a track address is calculated from the cluster address to access the track management table 23 and all cluster data in a track including the cluster data of the organizing target is managed by the forward-lookup cluster management table 12, and information in the track of the track management table 23 is invalidated.

When cluster data of an organizing target is collected for one block by repeating the above processing, the collected cluster data is written in the free block FB and the entries of the corresponding clusters of the forward-lookup cluster management table 12 and the track entry management table 25 are updated according to the write contents. Furthermore, the block management table 28 is updated so that the free block FB used as a collection destination of the cluster data is changed to the active block AB. The recorded locations of the collected cluster data before the organizing are obtained by accessing the forward-lookup cluster management table 12 and the track entry management table 25, the block number in which the cluster data is stored before is obtained from the obtained recorded locations, and the number of valid clusters in a list entry corresponding to the block number is updated by accessing the intra-block valid cluster number management table 26 from the block number. Finally, information on the block in which the cluster data is collected is reflected in the intra-block valid cluster number management table 26, the block LRU management table 27, and the reverse-lookup cluster management table 13. In this manner, when the access frequency is high, valid data of a block selected as an organizing target is managed in cluster units and the organizing of data is performed (Step S330).

Moreover, when determination at Step S310 is NO, the NAND organizing unit 34 performs the processing at Steps S360 and S370 to be described later.

On the other hand, when determination at Step S300 is NO, the NAND organizing unit 34 determines whether the number of the free blocks FB becomes equal to or less than the target value Fref (Step S340). When the number of the free blocks FB becomes equal to or less than the target, value Fref, it is determined whether the access frequency is low by checking whether the interval of a data transfer request from the host 1 is shorter than a threshold (for example, 5 seconds) (Step S350). When it is determined that the access frequency is low, a block on which writing is performed at the oldest time is selected as an organizing target candidate block by referring to the block LRU management table 27 (Step S360).

Then, the NAND organizing unit 34 obtains the number of valid clusters by accessing the intra-block valid cluster number management table 26 based on the number of the selected organizing target candidate block and compares the obtained number of valid clusters with a threshold Dn, and, when the number of valid clusters is equal to or less than the threshold Dn, determines this organizing target candidate block as an organizing target block. When the number of valid clusters is more than the threshold Dn, the NAND organizing unit 34 selects a block on which writing is performed at the second oldest time as an organizing target candidate block by referring to the block LRU management table 27 again and obtains the number of valid clusters of the selected organizing target candidate block in the similar manner, and performs the processing similar to the above. In this manner, the similar processing is repeated until an organizing target block can be determined.

After selecting a block as an organizing target in this manner, the NAND organizing unit 34 accesses the reverse-lookup cluster management table 13 from the block number of the organizing target block and obtains all of the addresses of the cluster data stored in the organizing target block. Then, the volatile cluster management table 24 and the forward-lookup cluster management table 12 are accessed from the obtained cluster addresses to determine whether the obtained clusters are valid, and only a valid cluster is set as cluster data as an organizing target.

When the cluster data as the organizing target is determined, a track address is calculated from the cluster address and the track data corresponding to the calculated track address is determined as an organizing target. For each cluster data stored in the organizing target block, processing similar to the above is performed to collect organizing target tracks for one block (in the present embodiment, four). Then, after obtaining the storage locations of the valid clusters forming these four organizing target tracks by accessing the volatile cluster management table 24, the forward-lookup cluster management table 12, and the track management table 23 and forming track data one by one by collecting valid clusters forming a track, each track data is written in the free block FB.

The corresponding entries in the track management table 23, the forward-lookup cluster management table 12, and the track entry management table 25 are updated according to the write contents. Furthermore, the block management table 28 is updated to change the free block FB used as a collection destination of the track data into the active block AB. In the similar manner to the above, the recorded locations of the collected track data and cluster data before the organizing are obtained by accessing the track management table 23, the forward-lookup cluster management table 12, and the track entry management table 25, the block number in which the track data and the cluster data are stored before is obtained from the obtained recorded locations, and the number of valid clusters in a list entry corresponding to the block number is updated by accessing the intra-block valid cluster number management table 26 from the block number. Finally, information on the block in which the track data and the cluster data are collected is reflected in the intra-block valid cluster number management table 26, the block LRU management table 27, and the reverse-lookup cluster management table 13.

At Step S360, when selecting a target block for the data organizing, a block with less valid data amount may be selected from among blocks whose write time is later than a threshold k1 and a block with less valid data amount may be selected from among blocks whose write time is older than a threshold k2, to collectively manage data whose write time is new in track units and collectively manage data whose write time is old in track units. By employing this method, it is possible to prevent that tracks whose write time is different are collected in the same block, so that unnecessary writing can be prevented.

The management table that needs to be updated in the data flushing from the WC 21 to the NAND flash 10 or in the data organizing in the NAND flash 10 is determined depending on the structure of the above-described management table group, the timing of backup of the management table in the DRAM 20 to the NAND flash 10, and the like and therefore needs to be appropriately set according to the required performance and processing complexity. For example, a method of performing only update of the volatile cluster management table 24 at the time of the data organizing in the NAND flash 10, a method of updating only the track management table 23 when track data is generated at the time of the defragmentation, and the like are considered.

In this manner, when the access frequency is low, valid data of a block selected as an organizing target is managed in track units and the organizing of data is performed (Step S370). When the free block FB becomes insufficient during the organizing, the processing (Steps S320 and S330) similar to the time when the access frequency is determined high is performed to generate the free block FB. If a predetermined condition is satisfied during the organizing when the access frequency is low, the organizing when the access frequency is low can be ended. As the predetermined condition, for example, the access frequency, the number of tracks with no fragmented cluster, the number of the free blocks FB, and the like can be used as a reference. It is possible to prevent rewriting of the NAND flash from being performed more than necessary by interrupting the organizing when the access frequency is low halfway.

In this manner, in the first embodiment, as the management unit of the DS 40 of the NAND flash 10, two units, i.e., a track as a large management unit and a cluster as a small management unit are provided, the forward-lookup cluster management table 12 managing a cluster is updated and managed in the NAND flash 10, the track management table 23 managing a track is updated and managed in the DRAM 20, and data arrangement and the management information inside are applied according to the access pattern from the host, so that the management system of improving both the random write performance and the random read performance can be realized without employing a large-capacity volatile semiconductor memory. Moreover, the volatile cluster management table 24 is provided in the DRAM 20 as a cache of the forward-lookup cluster management table 12 in the NAND flash 10, so that the access performance to the management information is improved.

Furthermore, in the present embodiment, when the access frequency from the host 1 is high, the organizing of data is performed by using a cluster that is a small management unit, so that the random write performance can be improved, and when the access from the host 1 decreases, the operation is performed by using a track as a large management unit and a cluster as a small management unit, so that the random read performance can be improved.

Furthermore, when the access frequency from the host 1 is high, all valid data of a data organizing target block is managed in cluster units and the organizing is performed, so that the free block FB can be increased at higher speed. Accordingly, the resource usage of the NAND flash 10 can be returned to the stable state at high speed, enabling to improve the random write performance.

Moreover, when the access frequency from the host is low, the organizing, such as rearranging fragmented cluster data in small management units in order of LBA as track data in large management units, is performed, so that, when the access frequency is low, it is possible to return to the management structure of performing control by combining two units, i.e., a large management unit and a small management unit, so that the read performance can be improved.

### Second Embodiment

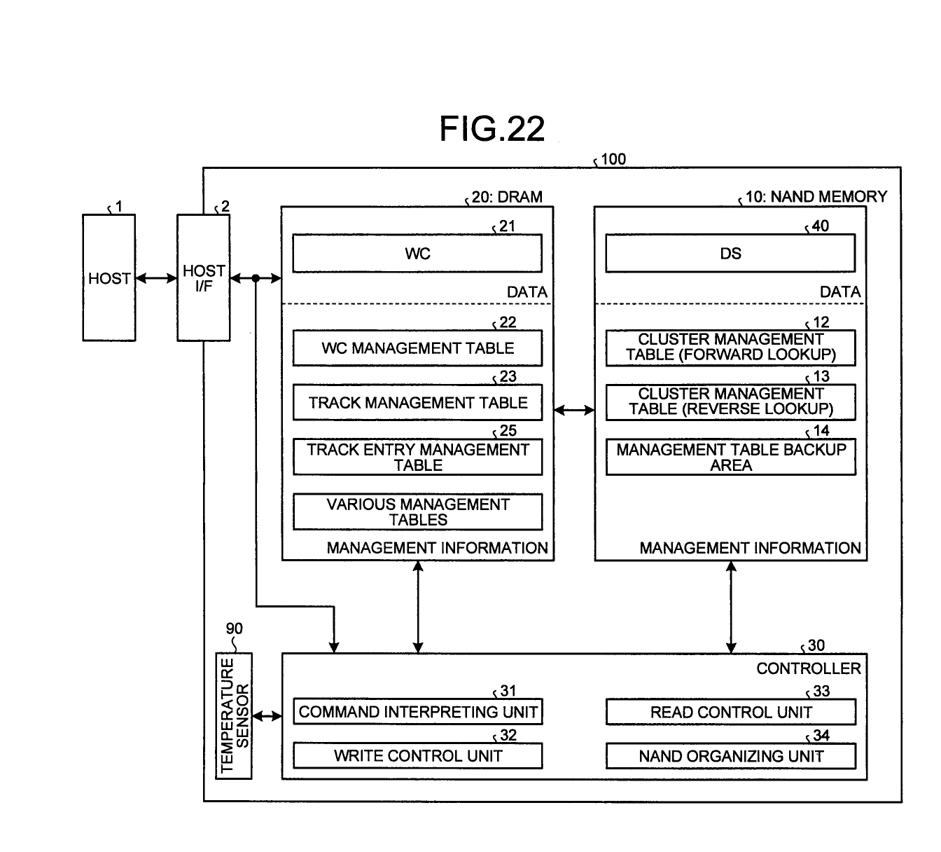

FIG. 22 is a functional block diagram illustrating a configuration example in the second embodiment of the SSD 100. In the second embodiment, the volatile cluster management table 24 that is employed in the first embodiment is not present, and management in cluster units is performed only by the forward-lookup cluster management table 12 in the NAND flash 10. Consequently, the capacity of the DRAM 20 can be further reduced. Other components and operations are similar to the first embodiment.

### Third Embodiment

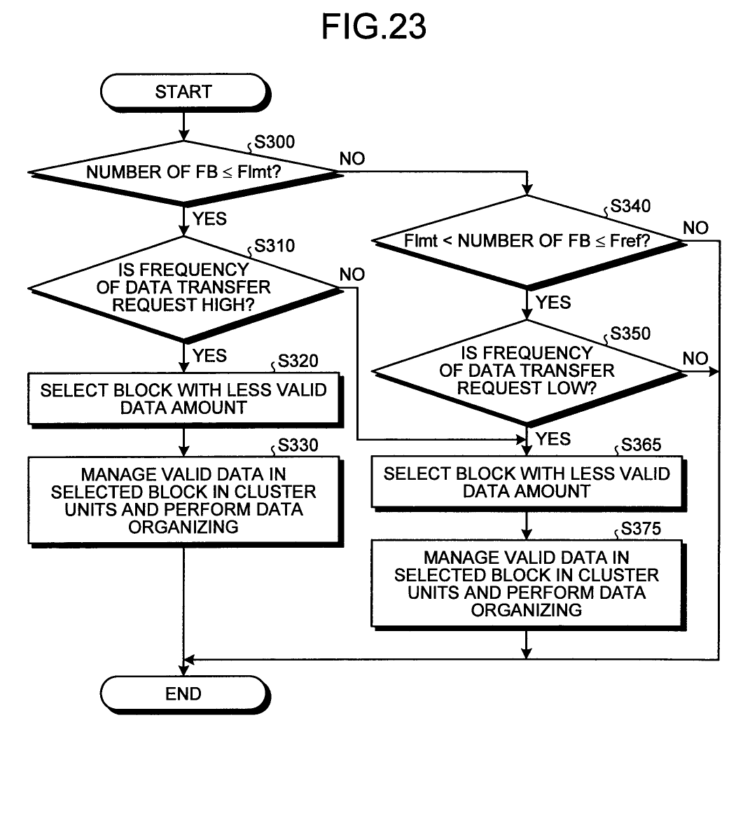

In the third embodiment, the method of the organizing of the NAND flash when the access frequency is low is made different from the first embodiment. FIG. 23 is a flowchart illustrating the organizing procedure of the NAND flash in the third embodiment. In the flowchart of FIG. 23, Step 365 and Step S375, which are operation procedures when the access frequency is low, are made different from the first embodiment (FIG. 21).

In the third embodiment, when the access frequency is low, a block with less valid data amount (for example, the number of valid clusters) is determined as a data organizing target block (Step S365), and all of the valid data in the determined block is managed in cluster units and the organizing (cluster merge and cluster compaction) is performed (Step S375). Consequently, in the third embodiment, even when the access frequency is low, the resource amount of the NAND flash 10 can be returned to the stable state immediately.

In this third embodiment, the organizing of the NAND flash accompanying conversion of the management unit from a cluster unit to a track unit may be performed when the SSD 100 transitions to a standby state or at the time of power-off sequence.

Moreover, at Step S365, when selecting a target block for the data organizing, a block with less valid data amount may be selected from among blocks whose write time is later than a threshold k3 and a block with less valid data amount may be selected from among blocks whose write time is older than a threshold k4, to collectively manage data whose write time is new in cluster units and collectively manage data whose write time is old in cluster units. By employing this method, it is possible to prevent that clusters whose write time is different are collected in the same block, so that unnecessary writing can be prevented.

### Fourth Embodiment

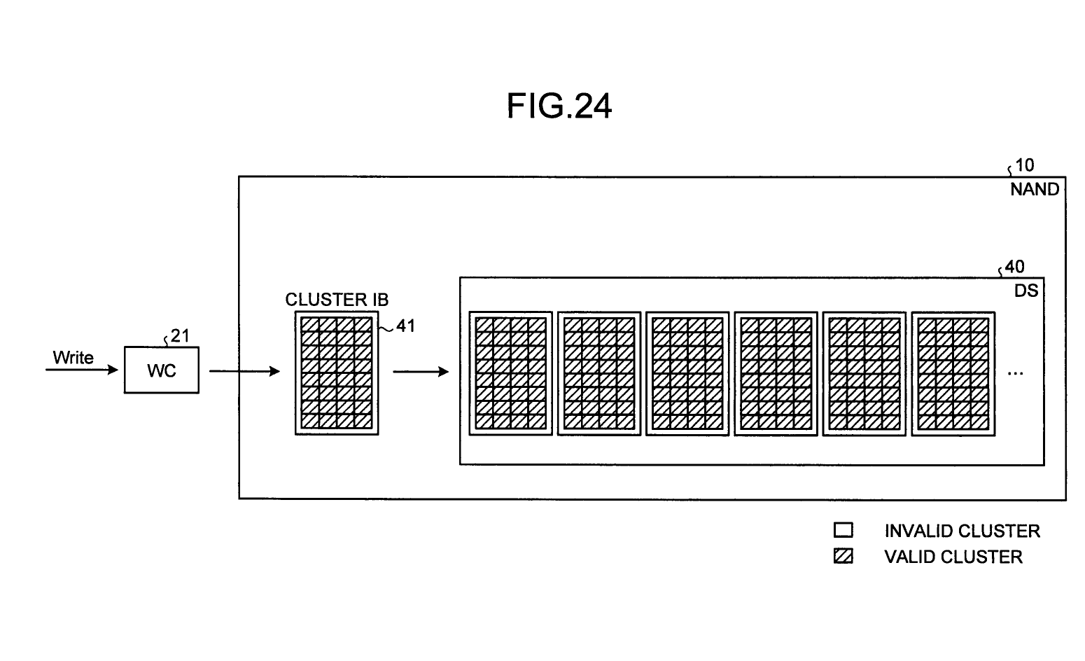

FIG. 24 illustrates a flush structure from the WC 21 to the NAND flash 10 in the fourth embodiment. In the fourth embodiment, when flushing from the WC 21 to the NAND flash 10, all data is flushed to the cluster IB 41 in cluster units without performing selection of the management unit. Then, in the fourth embodiment, as shown in Steps S360 and S370 in FIG. 21, conversion of the management unit from a cluster unit to a track unit is performed by the organizing of the NAND flash when the access frequency is low. In other words, track data is first generated by the NAND organizing when the access frequency is low.

### Fifth Embodiment

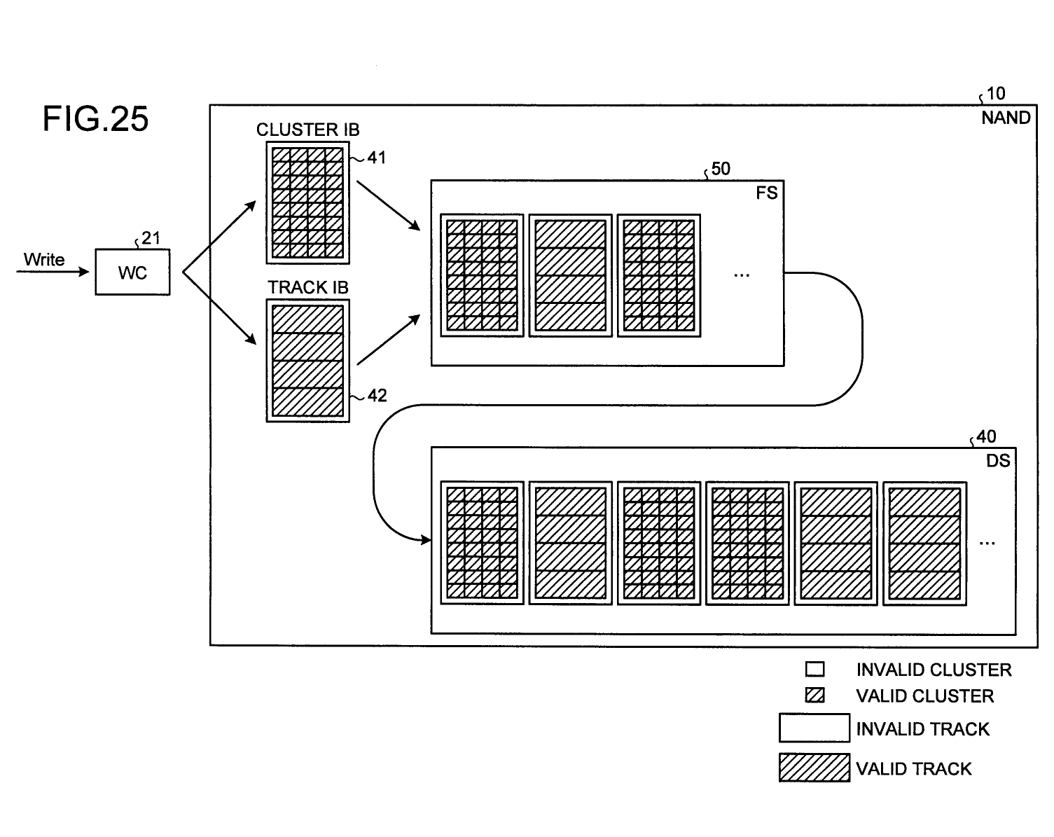

FIG. 25 functionally illustrates the storage area of the NAND flash 10 in the fifth embodiment. In the fifth embodiment, a pre-stage storage (FS: Front Storage) 50 is arranged on the front stage of the DS 40. The FS 50 is a buffer in which data is managed in cluster units and track units in the similar manner to the DS 40, and when the cluster IB 41 or the track IB 42 becomes full of data, the cluster IB 41 or the track IB 42 moves to the management under the FS 50.

The FS 50 has an FIFO structure in which a block is managed in order (LRU) of data writing in the similar manner to the DS 40. When cluster data or track data of the same LBA as cluster data or track data present in the FS 50 is input to the FS 50, it is sufficient to invalidate the cluster data or the track data in the FS 50 and rewriting is not performed.

The cluster data or the track data of the same LBA as the cluster data or the track data input to the FS 50 is invalidated in a block, and a block in which all of the cluster data or the track data in the block is invalidated is released as the free block FB. A block that reaches the end of the FIFO management structure of the FS 50 is regarded as data that is less likely to be rewritten from the host 1 and is moved to the management under the DS 40.

Frequently updated data is invalidated while passing through the FS 50 and only infrequently updated data overflows from the FS 50, so that the FS 50 can separate frequently updated data from infrequently updated data. The NAND organizing unit 34 excludes the FS 50 as a data organizing target, so that frequently updated data and infrequently updated data are prevented from being mixed in the same block. In other words, in this fifth embodiment, the storage is divided into the FS 50 and the DS 40 based on the time order of the write time of a block and storage management similar to the fifth embodiment can be performed also by using the block LRU management table 27 shown in FIG. 12.

### Sixth Embodiment

In the sixth embodiment, a modified example of flushing from the WC 21 to the NAND flash 10 (the cluster IB 41 or the track IB 42) and the switching rule of the management unit explained in FIG. 18 and the like is described.

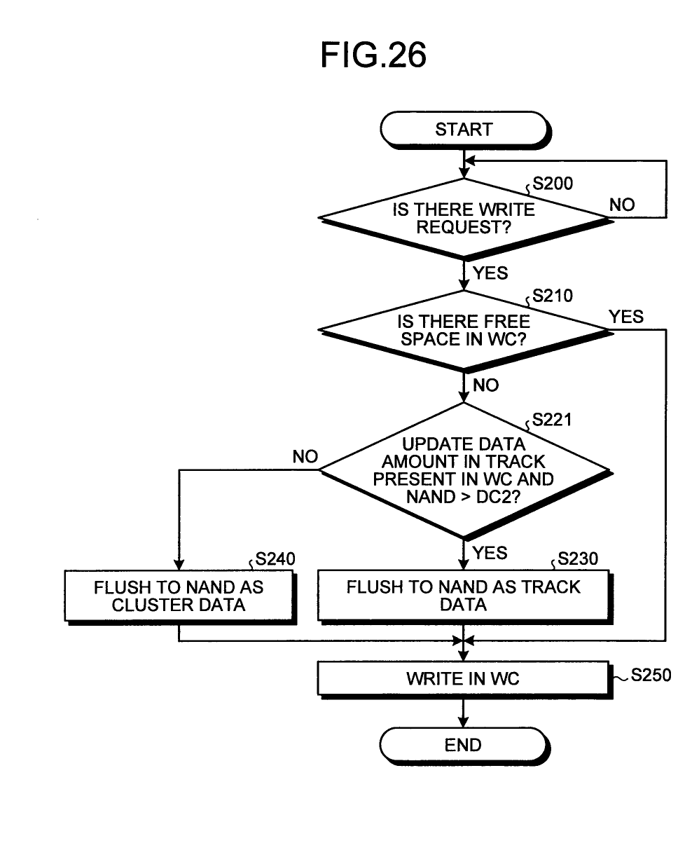

FIG. 26 is a flowchart illustrating the first example of the sixth embodiment. In FIG. 18, the management unit is switched by referring to the update data amount (or the update data rate) cached in the WC 21 in a track, however, in FIG. 26, the update data amount (or the update data rate) in the WC 21 and the NAND flash 10 in the same track is referred to. Specifically, as shown in FIG. 15, after once being written in the NAND flash 10 as track data by a write request from the host 1 or after being formed into a track by the defragmentation processing and written in the NAND flash 10, when data in the same track is updated by a write request from the host 1, as shown in FIG. 16 or FIG. 17, data in the same track is distributed (fragmented) in a different block in the WC 21 or the NAND flash 10. In the first example, switching of the management unit is performed by referring to the total amount of data in the same track arranged in the WC 21 and data in the same track fragmented and distributed in the NAND flash 10.

In FIG. 26, Step S220 in FIG. 18 is changed to Step S221. Specifically, in FIG. 26, when there is no free space in the WC 21 (Step S210: YES), the write control unit 32 calculates the update data amount of data included in the same track for each track in the WC 21 and the NAND flash 10 and compares the calculated update data amount with a threshold DC2 (Step S221), flushes data included in a track in which the update data amount is equal to or more than the threshold DC2 to the track IB 42 as track data (Step S230), and flushes data included in a track in which the update data amount is less than the threshold DC2 to the cluster IB 41 as cluster data (Step S240).

When calculating the update data amount in a track in the WC 21, as described above, the update data amount in a track may be calculated by using a valid sector address in the WC management table 22 shown in FIG. 5 or the update data amount in a track may be sequentially calculated for each track and stored in the DRAM 20 as the management information and this stored management information may be used. Moreover, when calculating the update data amount in a track in the NAND flash 10, the number of fragmentations in the track management table 23 shown in FIG. 6 is used.

Specifically, the update data amount (update data rate) in a track being large means that data is likely to be distributed and the read performance is likely to decrease, so that the read performance is improved by collecting data in a track and flushing the data to the NAND flash 10.

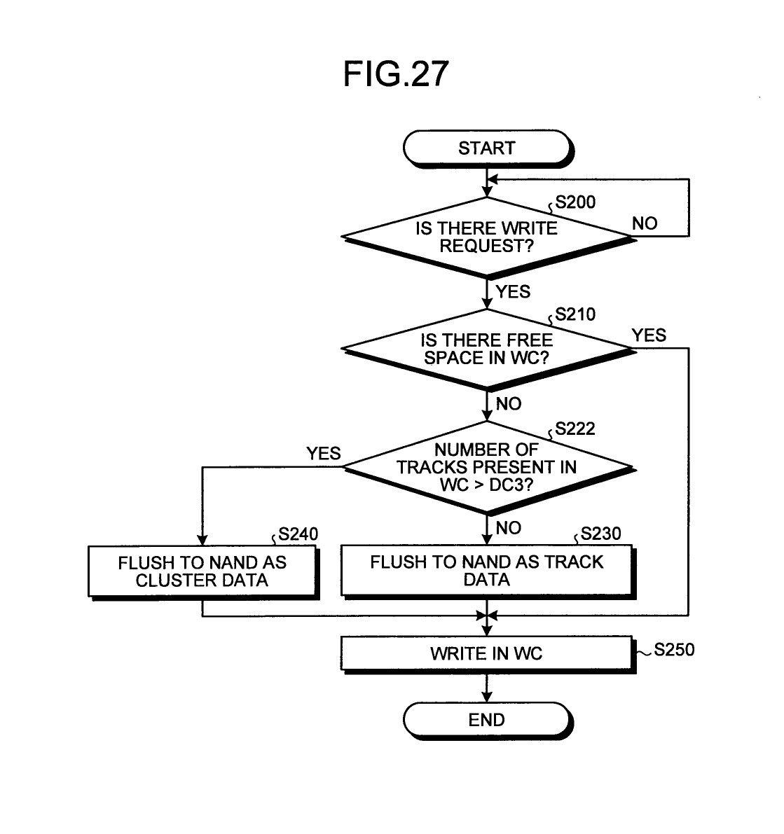

FIG. 27 is a flowchart illustrating the second example of the sixth embodiment. In FIG. 27, the management unit is switched by referring to the number of tracks (the number of different track addresses) cached in the WC 21. In FIG. 27, Step S220 in FIG. 18 is changed to Step S222 and Yes and No at Step S222 are reversed from Step S220 in FIG. 18. In FIG. 27, when there is no free space in the WC 21 (Step S210: YES), the write control unit 32 calculates the number of tracks in the WC 21 and compares this calculated number of tracks with a threshold DC3 (Step S222), flushes data in the WC 21 to the cluster IB 41 as cluster data under the condition that the number of tracks in the WC 21 is equal to or more than the threshold DC3 (Step S240), and flushes data in the WC 21 to the track IB 42 as track data under the condition that the number of tracks in the WC 21 is less than the threshold DC3 (Step S230).

When deriving the number of tracks in the WC 21, as described above, the number of tracks may be calculated by using a valid sector address in the WC management table 22 shown in FIG. 5 or the number of tracks in the WC 21 may be sequentially calculated and stored in the DRAM 20 as the management information and this stored management information may be used. Moreover, when a table that manages data stored in the WC 21 in track units is employed as the WC management table 22, the number of valid track entries in the WC management table 22 may be calculated.

When flushing data from the WC 21, if the number of tracks is large, it is predicted that a read/write amount by track writing becomes large and random pattern writing is performed. Therefore, when flushing data from the WC 21, if the number of tracks is large, cluster writing is performed so that the write performance does not decrease.

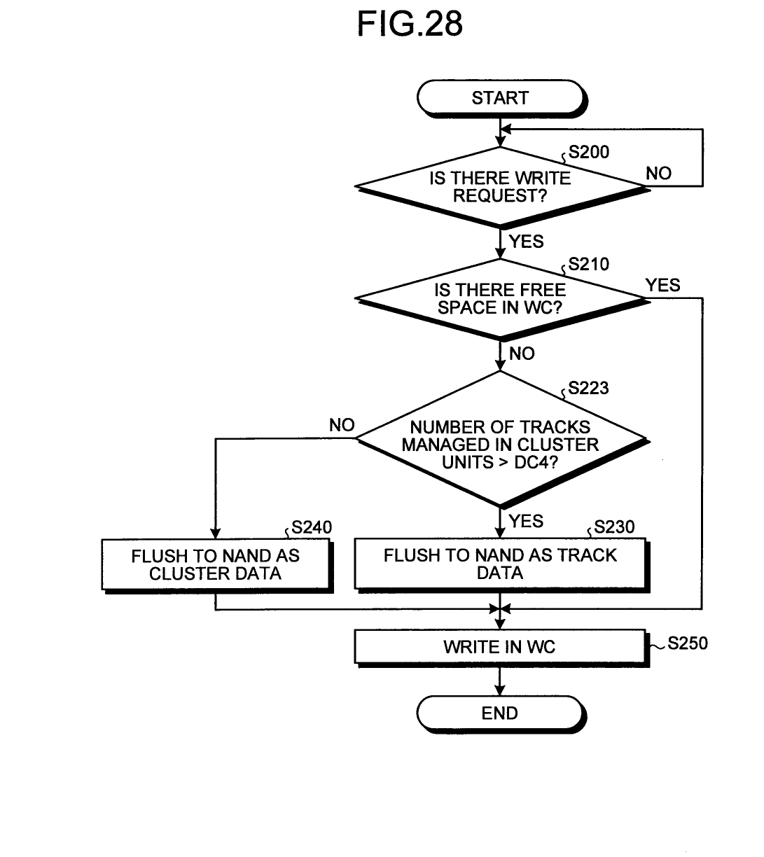

FIG. 28 is a flowchart illustrating the third example of the sixth embodiment. In FIG. 28, in the NAND flash 10, the management unit is switched by referring to the number of tracks managed in cluster units. In FIG. 28, Step S220 in FIG. 18 is changed to Step S223. In FIG. 28, when there is no free space in the WC 21 (Step S210: YES), the write control unit 32 calculates the number of tracks managed in cluster units in the NAND flash 10 and compares this calculated number of tracks with a threshold DC4 (Step S223), flushes data to the track IB 42 as track data when the number of tracks managed in cluster units is equal to or more than the threshold DC4 (Step S230), and flushes data to the cluster IB 41 as cluster data when the number of tracks managed in cluster units is less than the threshold DC4 (Step S240).

A track managed in cluster units is a track, which is a valid track entered in the track management table 23 shown in FIG. 6 and in which a cluster in the same track is present in a block that is different from a block in which a storage location is registered corresponding to a track address in the track management table 23. Therefore, when calculating the number of tracks managed in cluster units in the NAND flash 10, for example, in the track management table 23 shown in FIG. 6, the number of tracks in which the track valid/invalid flag is valid and the fragmentation flag indicates that fragmentation is present is calculated. The number of tracks managed in cluster units may be stored in the management information and this stored management information may be managed.

When tracks managed in track units decrease due to the organizing (cluster merge) of the NAND flash 10 and the like, in other words, when tracks managed in cluster units increase, the read performance may decrease, so that when flushing data from the WC 21, if tracks managed in track units decrease, track flushing is performed on a track whose data is present in the WC 21.

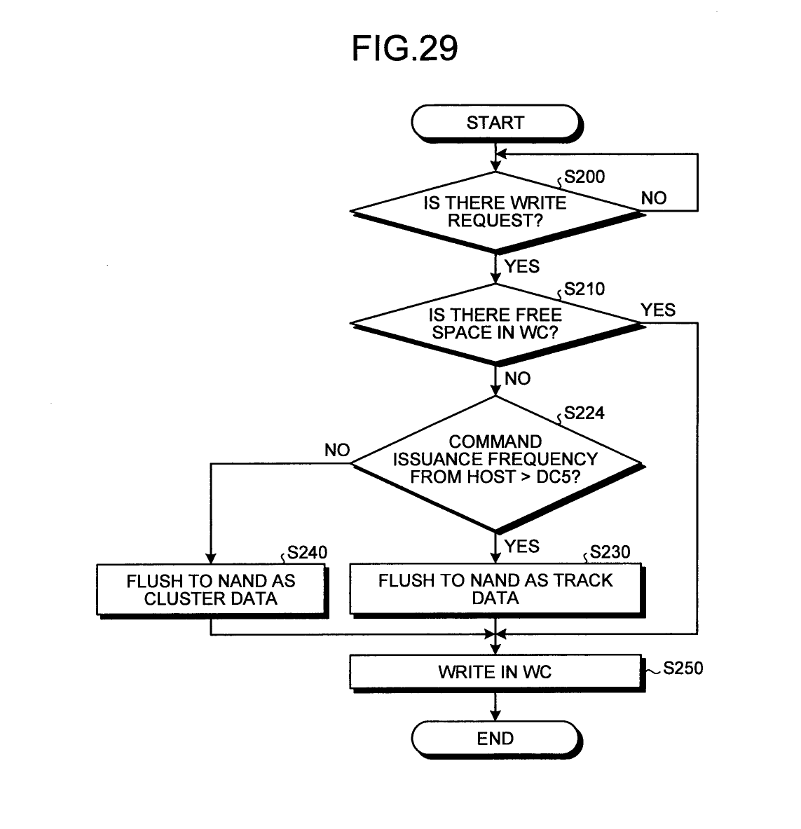

FIG. 29 is a flowchart illustrating the fourth example of the sixth embodiment. In FIG. 29, a command issuance frequency from the host 1 is referred to. In FIG. 29, Step S220 in FIG. 18 is changed to Step S224. In FIG. 29, when there is no free space in the WC 21 (Step S210: YES), the write control unit 32 derives the command issuance frequency from the host 1. As the command issuance frequency, for example, a data transfer request interval from the host 1 is derived. Then, the derived data transfer request interval is compared with a threshold time DC5 (Step S223). When the data transfer request interval from the host 1 is equal to or more than the threshold time DC5, data is flushed as track data (Step S230), and when the data transfer request interval from the host 1 is less than the threshold DC5, data is flushed as cluster data (Step S240). In other words, when the command issuance frequency from the host 1 is low, data is flushed as a track, and when the command issuance frequency from the host 1 is high, data is flushed as a cluster.

When the command issuance frequency from the host 1 is low, the effect of time increment for writing as a track is low, so that data is flushed as a track for preventing decrease in the read performance, and on the contrary, when the frequency is high, time increment due to formation of a track leads to a performance degradation, so that writing is performed as a cluster. The command issuance frequency may be determined by the transfer rate between the host 1 and the SSD 100. Specifically, when the transfer rate between the host 1 and the SSD 100 is equal to or less than a threshold, data may be flushed as track data, and when the transfer rate between the host 1 and the SSD 100 is larger than the threshold, data may be flushed as cluster data.

Moreover, data whose management information is present in the DRAM 20 may be flushed as cluster data and data whose management information is present in the NAND flash 10 may be flushed as track data.

### Seventh Embodiment

In the seventh embodiment, another example of the method of selecting a data organizing target block when performing the defragmentation is explained. In the first embodiment, when the access frequency is low, if the resource usage of the NAND flash 10 exceeds the target value Fref, the defragmentation of collecting clusters in order of LBA and forming them into a track is started, and when further performing the defragmentation, a block with less valid data amount among blocks whose write time is old is selected as an organizing target block, however, when performing the defragmentation, data of a block whose write time is older than a threshold may be selected as an organizing target block or an organizing target block may be selected from data whose write time is older.

Moreover, when performing the defragmentation, a block in which the valid data amount is less than a threshold may be selected as an organizing target block or an organizing target block may be selected from blocks with less valid data amount.

Furthermore, when performing the defragmentation, a block that is read-accessed frequently may be selected as an organizing target block. Specifically, the number of times of reading (or a read data amount) for each block is counted by using the block management table 28 shown in FIG. 13, and when performing the defragmentation, a block whose number of times of reading (or a read data amount) is more than a threshold is selected by using the block management table 28 and the selected block is set as an organizing target block. With this method, the read speed is increased by selecting a block for which reading occurs frequently and forming data in the block into a track. When the defragmentation is finished, the number of times of reading of the block management table 28 is reset to zero.

Moreover, when performing the defragmentation, clusters that belong to a track in which the update data amount is more than a threshold may be collected. Specifically, a block that includes clusters belonging to a track in which the update data amount is more than a threshold is selected as a target block for the defragmentation and the clusters in the selected defragmentation target block are collected to be formed into a track. For example, a track in which the update data amount is large is selected by selecting a track in which the number of fragmentations in the track management table 23 shown in FIG. 6 is equal to or more than a threshold. The number of fragmentations being large means that the number of clusters discrete in other blocks as a cluster is large after being formed into a track and therefore provides an indication of determining a track in which the update data amount is large. In this method, clusters in tracks in which clusters are likely to be discrete in each block are collected to be formed into a track, so that the read speed can be increased.

Furthermore, when performing the defragmentation, clusters belonging to a track that is read-accessed frequently may be collected. Specifically, a block that includes clusters belonging to a track that is read-accessed more than a threshold is selected as a target block for the defragmentation and the clusters in the selected defragmentation target block are collected to be formed into a track. For example, a track that is read-accessed frequently is selected by selecting a track in which the read data amount (the number of times of reading) in the track management table 23 shown in FIG. 6 is equal to or more than the threshold. In this method, tracks for which reading occurs frequently are selected and clusters belonging to the tracks are formed into a track, thereby increasing the read speed. When the defragmentation is finished, the read data amount in the track management table 23 is reset to zero.

### Eighth Embodiment

Next, another example of a starting condition of the defragmentation is explained. In the first embodiment, when the access frequency is low, if the resource usage of the NAND flash 10 exceeds the target value Fref, the defragmentation of collecting clusters in order of LBA and forming them into a track is started, however, in the eighth embodiment, if the resource usage of the NAND flash 10 exceeds the target value Fref, when the number of tracks managed in cluster units becomes equal to or more than a threshold, the defragmentation is started. As explained in the sixth embodiment, the number of tracks managed in cluster units is obtained by calculating the number of tracks in which the track valid/invalid flag is valid and fragmentation is present in the track management table 23 shown in FIG. 6.

In this eighth embodiment, when tracks managed in track units decrease, in other words, when tracks managed in cluster units increase, this is regarded as satisfying the defragmentation starting condition and the defragmentation is performed, whereby tracks managed in track units increase, enabling to improve the read speed. Moreover, when start of the defragmentation is triggered by using the method of this eighth embodiment, the selecting method of a defragmentation target block or defragmentation target data explained in the above first embodiment or seventh embodiment may be employed. That is, when performing the defragmentation, at least one of the followings may be employed.
data of a block whose write time is older than a threshold is selected as a defragmentation target block
a block in which the valid data amount is less than a threshold is selected as a defragmentation target block
a block whose write time is older than a threshold and in which the valid data amount is less than a threshold is selected as a defragmentation target block
a block that is read-accessed more than a threshold is selected as an organizing target block
defragmentation is performed by collecting clusters belonging to a track in which the update data amount is more than a threshold
defragmentation is performed by collecting clusters belonging to a track that is read-accessed frequently

### Ninth Embodiment

In the ninth embodiment, another example of the cluster compaction is described. In the first embodiment, when the access frequency from the host 1 is high, the cluster compaction is performed by selecting a block in which the valid data amount is less than a threshold as an organizing target block, however, when the access frequency is high, a block whose write time is older than a threshold and in which the valid data amount is less than a threshold may be selected as a target block for the cluster compaction. When selecting a block whose write time is older than a threshold, any method of using the block LRU management table 27 shown in FIG. 12 and separating a storage into the FS 50 and the DS 40 based on the time order of the write time of a block as shown in FIG. 25 may be employed.

Moreover, in the first embodiment, when the access frequency is low, the cluster compaction is performed after the number of the free blocks FB becomes smaller than a threshold by performing the organizing of the NAND flash 10 such as the defragmentation, however, under any condition, when the number of the free blocks FB becomes smaller than a threshold, the cluster compaction may be performed. Moreover, in the first embodiment, the cluster compaction is performed by collecting valid clusters that were not targeted for the track compaction and the defragmentation in one free block FB, however, a block in which the valid data amount is less than a threshold may be selected as a target block for the cluster compaction, and moreover, a block whose write time is older than a threshold and in which the valid data amount is less than a threshold may be selected as a target block for the cluster compaction.

Furthermore, when the access frequency from the host 1 is low, the decomposition (cluster merge) of a track or the cluster compaction of collecting data of tracks in which the write data amount is more than a threshold in one block may be performed. In this method, for example, a track that is write-accessed frequently is selected by selecting a track in which the write data amount (the number of times of writing) in the track management table 23 shown in FIG. 6 is equal to or more than a threshold. With this method, the write speed is improved by collecting tracks that are write-accessed frequently in one block.

### Tenth Embodiment

In the tenth embodiment, the temperature of the SSD 100 is used as a start parameter of the organizing of the NAND flash 10. The temperature sensor 90 (refer to FIG. 1 and FIG. 22) is mounted on the SSD 100, and when the ambient temperature is lower than a threshold based on the output of the temperature sensor 90, the defragmentation explained in the seventh or eighth embodiment is performed. Furthermore, when the ambient temperature is equal to or lower than the threshold, the decomposition (cluster merge) of a track of collecting data of tracks in which the write data amount is more than a threshold in one block may be performed. The temperature sensor may be provided adjacent to the controller 30 or the NAND flash 10. The arrangement location of the temperature sensor is arbitrary as long as the temperature sensor is provided on the substrate of the SSD 100 on which the NAND flash 10, the DRAM 20, and the controller 30 are mounted, and a plurality of temperature sensors may be provided. Moreover, the configuration may be such that the SSD 100 itself does not include the temperature sensor and information including the ambient temperature is notified from the host 1.

On the other hand, when the ambient temperature is equal to or higher than the threshold, the cluster compaction of selecting a block in which the valid data amount is less than a threshold as an organizing target block, or the cluster compaction of selecting a block whose write time is older than a threshold and in which the valid data amount is less than a threshold as an organizing target block is performed. In the cluster compaction, the read/write access with respect to the NAND flash 10 is reduced and a power consumption amount and temperature rise are small compared with the defragmentation or the decomposition (cluster merge) of a track, so that the cluster compaction is performed when the ambient temperature is high. On the contrary, the defragmentation or the decomposition (cluster merge) of a track are performed when the ambient temperature is low.

### Eleventh Embodiment

In the eleventh embodiment, the power consumption amount of the SSD 100 is used as a start parameter of the organizing of the NAND flash 10. Under the condition in which the power consumption amount of the SSD 100 can be equal to or more than a threshold, the defragmentation or the decomposition (cluster merge) of a track in which the power consumption amount is relatively high is performed, and, under the condition in which the power consumption amount of the SSD 100 cannot be equal to or more than the threshold, the cluster compaction in which the power consumption amount is relatively low is performed. For example, the host 1, according to the power capability of itself, notifies the SSD 100 of an allowable power consumption amount. Upon reception of the notification, the controller 30 can determine whether the notified allowable power consumption amount is equal to or more than a threshold.

### Twelfth Embodiment

A target block for the data organizing may be determined by using the following method.
A block in which the valid data amount is less than a threshold among blocks whose write time is later than a threshold is determined as a data organizing target. With this method, because data whose write time is the same (new) period is collected to be rewritten in one block, it is prevented that data whose write time is different is mixed in one block.
A block in which the number of tracks to which each cluster belongs in a block is large is determined as a data organizing target.
A block in which the number of tracks to which each cluster belongs in a block is small is determined as a data organizing target.
A block that is write-accessed frequently is determined as a data organizing target. In this case, valid data of the block targeted for the organizing is managed in cluster units to be subjected to the compaction or the cluster merge.

Moreover, in the above embodiment, when determining an organizing target block, the number of valid clusters is referred to as the valid data amount in a block, however, an organizing target block may be selected based on the ratio (proportion) of a valid cluster in a block. The ratio of a valid cluster in a block is, for example, obtained by an amount (number) of valid clusters/an amount (number) of clusters capable of writing. Moreover, when flushing from the WC 21, the update data amount in a track or the valid data amount in a track is referred to, however, the update data rate in a track or the valid data rate in a track may be referred to. In the similar manner, in the above embodiment, determination by referring to the amount of data and the number of data may be replaced by determination by referring to the data rate.

Furthermore, a block in which the management table in the NAND table 10 is stored may be included as an organizing target. Moreover, a block managed in cluster units may be recorded in an SLC (Single Level Cell) and a block managed in track units may be recorded in an MLC (Multi Level Cell). The SLC indicates a method of recording one bit in one memory cell and the MLC indicates a method of recording two or more bits in one memory cell. It is also possible to manage in a pseudo SLC method by using only part of bits in the MLC. Moreover, the management information may be recorded in the SLC.

### Thirteenth Embodiment

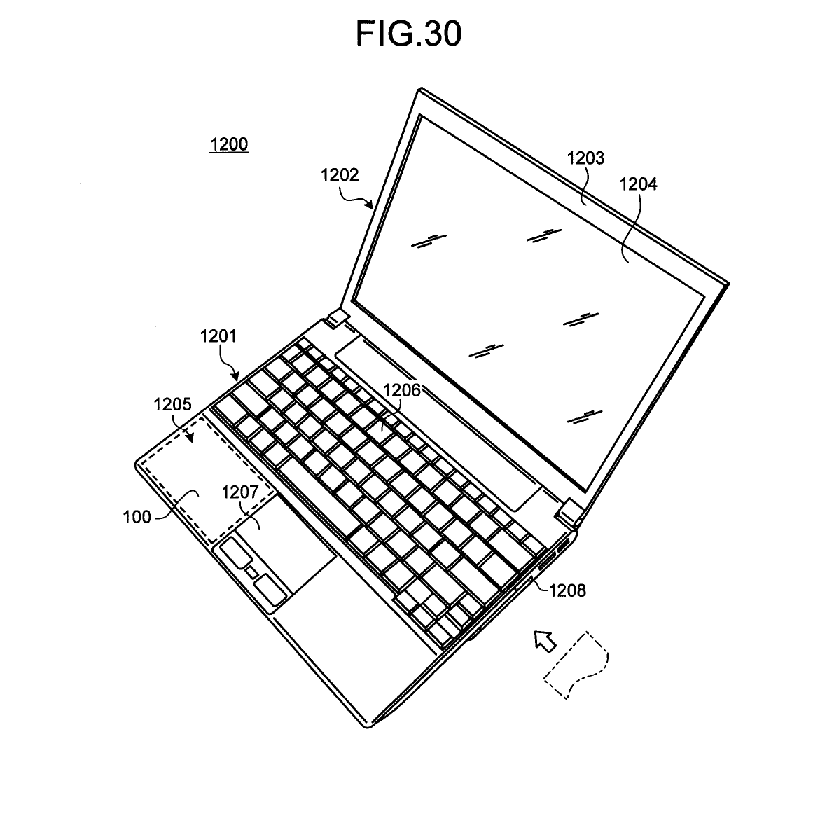

FIG. 30 is a perspective view of an example of a PC 1200 on which the SSD 100 is mounted. The PC 1200 includes a main body 1201 and a display unit 1202. The display unit 1202 includes a display housing 1203 and a display device 1204 accommodated in the display housing 1203.

The main body 1201 includes a chassis 1205, a keyboard 1206, and a touch pad 1207 as a pointing device. The chassis 1205 includes therein a main circuit board, an ODD (Optical Disk Device) unit, a card slot, the SSD 100, and the like.

The card slot is provided so as to be adjacent to the peripheral wall of the chassis 1205. The peripheral wall has an opening 1208 facing the card slot. A user can insert and remove an additional device into and from the card slot from outside the chassis 1205 through this opening 1208.

The SSD 100 may be used instead of a conventional HDD in the state of being mounted on the PC 1200 or may be used as an additional device in the state of being inserted into the card slot provided in the PC 1200.

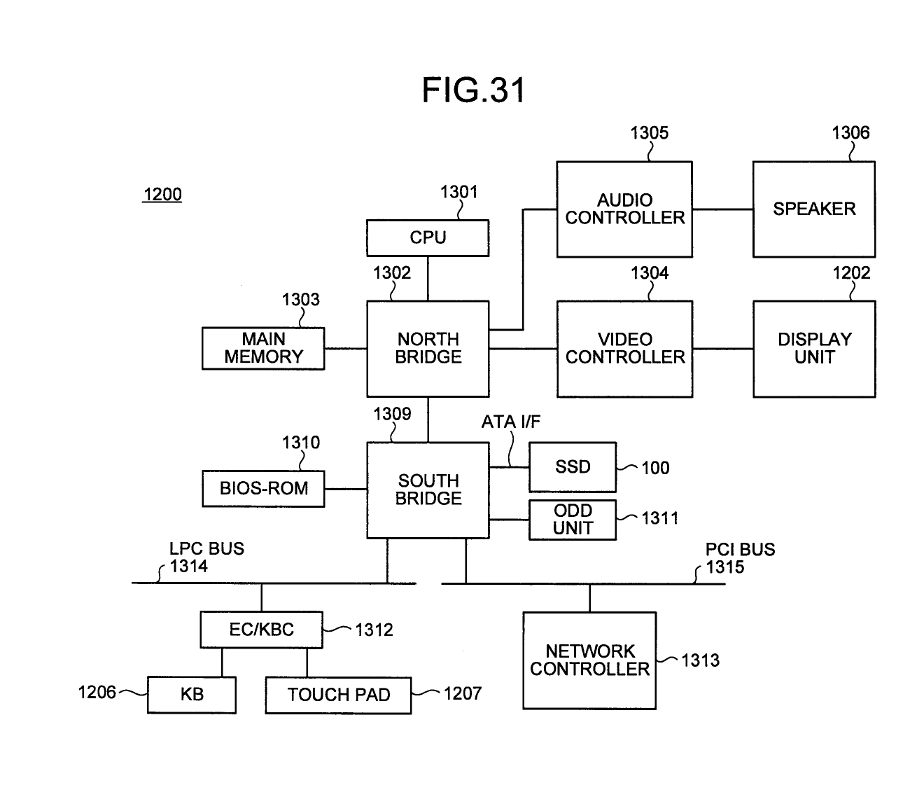

FIG. 31 illustrates a system configuration example of the PC on which the SSD is mounted. The PC 1200 includes a CPU 1301, a north bridge 1302, a main memory 1303, a video controller 1304, an audio controller 1305, a south bridge 1309, a BIOS-ROM 1310, the SSD 100, an ODD unit 1311, an embedded controller/keyboard controller IC (EC/KBC) 1312, a network controller 1313, and the like.

The CPU 1301 is a processor provided for controlling an operation of the PC 1200, and executes an operating system (OS) loaded from the SSD 100 onto the main memory 1303. Furthermore, when the ODD unit 1311 is capable of executing at least one of read processing and write processing on a mounted optical disk, the CPU 1301 executes the processing.

Moreover, the CPU 1301 executes a system BIOS (Basic Input Output System) stored in the BIOS-ROM 1310. The system BIOS is a program for controlling a hardware in the PC 1200.

The north bridge 1302 is a bridge device that connects a local bus of the CPU 1301 to the south bridge 1309. The north bridge 1302 has a memory controller for controlling an access to the main memory 1303.

Moreover, the north bridge 1302 has a function of executing a communication with the video controller 1304 and a communication with the audio controller 1305 through an AGP (Accelerated Graphics Port) bus or the like.

The main memory 1303 temporarily stores therein a program and data, and functions as a work area of the CPU 1301. The main memory 1303, for example, consists of a DRAM.

The video controller 1304 is a video reproduction controller for controlling the display unit 1202 used as a display monitor of the PC 1200.

The audio controller 1305 is an audio reproduction controller for controlling a speaker 1306 of the PC 1200.

The south bridge 1309 controls each device on an LPC (Low Pin Count) bus 1314 and each device on a PCI (Peripheral Component Interconnect) bus 1315. Moreover, the south bridge 1309 controls the SSD 100 that is a memory device storing various types of software and data through the ATA interface.

The PC 1200 accesses the SSD 100 in sector units. A write command, a read command, a cache flush command, and the like are input to the SSD 100 through the ATA interface.

The south bridge 1309 has a function of controlling an access to the BIOS-ROM 1310 and the ODD unit 1311.

The EC/KBC 1312 is a one-chip microcomputer in which an embedded controller for power management and a keyboard controller for controlling the keyboard (KB) 1206 and the touch pad 1207 are integrated.

This EC/KBC 1312 has a function of turning on/off the PC 1200 based on an operation of a power button by a user. The network controller 1313 is, for example, a communication device that executes communication with an external network such as the Internet.

As the information processing apparatus on which the SSD 100 is mounted, an imaging device, such as a still camera and a video camera, can be employed. Such an information processing apparatus can improve random read and random write performance by mounting the SSD 100. Accordingly, convenience of a user who uses the information processing apparatus can be improved.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A semiconductor storage device comprising:
a first storage area included in a first semiconductor memory capable of random access;
a second storage area included in a nonvolatile second semiconductor memory in which reading and writing is performed by a page unit and erasing is performed by a block unit larger than the page unit; and
a controller that allocates a storage area of the second semiconductor memory to the second storage area by the block unit, wherein
the controller configured to:
records a first management table for managing data in the second storage area by a first management unit, into the second semiconductor memory;
records a second management table for managing data in the second storage area by a second management unit larger than the first management unit, into the first semiconductor memory;
performs a data flush processing of flushing a plurality of data in a sector unit written in the first storage area to the second storage area as any one of data in the first management unit and data in the second management unit and updates at least one of the first management table and the second management table; and
when a resource usage of the second storage area exceeds a threshold, performs a data organizing processing of collecting valid data from the second storage area and rewriting into another block in the second storage area and updates at least one of the first management table and the second management table.

2. The semiconductor storage device according to claim 1, wherein the controller configured to:
records a third management table, which is a cache of at least part of the first management table, into the first semiconductor memory;
updates at least one of the first management table, the second management table, and the third management table according to the data flush processing to the second storage area; and
updates at least one of the first management table, the second management table, and the third management table according to the data organizing processing in the second storage area.

3. The semiconductor storage device according to claim 1, wherein, in the data flush processing, the controller configured to:
flushes data in a sector unit written in the first storage area to the second storage area as data in the second management unit when number of data included in an address in the second management unit is equal to or more than a predetermined threshold in the first storage area; and
flushes data in a sector unit written in the first storage area to the second storage area as data in the first management unit when the number of data is less than the predetermined threshold.

4. The semiconductor storage device according to claim 1, wherein, in the data flush processing, the controller configured to:
flushes data in a sector unit written in the first storage area to the second storage area as data in the second management unit when number of data, which is included in an address in the second management unit and is written in the first and second storage areas after being written in the second storage area as data in the second management unit, is equal to or more than a predetermined threshold; and
flushes data in a sector unit written in the first storage area to the second storage area as data in the first management unit when the number of data is less than the predetermined threshold.

5. The semiconductor storage device according to claim 1, wherein, in the data flush processing, the controller configured to:
flushes data in a sector unit written in the first storage area to the second storage area as data in the first management unit when number of addresses in the second management unit, to which data stored in the first storage area belongs, is equal to or more than a predetermined threshold; and
flushes to the second storage area as data in the second management unit when the number of addresses is less than the predetermined threshold.

6. The semiconductor storage device according to claim 1, wherein, in the data flush processing, the controller configured to:
flushes data in a sector unit written in the first storage area to the second storage area as data in the second management unit when number of addresses in the second management unit, whose data is written in the first and second storage areas after being written in the second storage area as data in the second management unit, is equal to or more than a predetermined threshold; and
flushes to the second storage area as data in the first management unit when the number of addresses is less than the predetermined threshold.

7. The semiconductor storage device according to claim 1, wherein, in the data flush processing, the controller configured to:
flushes data in a sector unit written in the first storage area to the second storage area as data in the first management unit when an access frequency from a host apparatus is equal to or more than a threshold; and
flushes to the second storage area as data in the second management unit when the access frequency is less than the threshold.

8. The semiconductor storage device according to claim 1, wherein, in the data organizing processing, the controller collects valid data from a selected organizing target block and rewrites into another block as data in the second management unit when an access frequency from a host apparatus is less than a threshold.

9. The semiconductor storage device according to claim 8, wherein the controller preferentially selects a block whose write time is older than a predetermined threshold, as an organizing target block.

10. The semiconductor storage device according to claim 8, wherein the controller preferentially selects a block in which number of valid data or a valid data rate is smaller than a predetermined threshold, as an organizing target block.

11. The semiconductor storage device according to claim 8, wherein the controller preferentially selects a block whose write time is older than a predetermined threshold and in which number of valid data or a valid data rate is smaller than a predetermined threshold, as an organizing target block.

12. The semiconductor storage device according to claim 8, wherein the controller preferentially selects a block that is read-accessed more than a predetermined threshold, as an organizing target block.

13. The semiconductor storage device according to claim 8, wherein the controller preferentially selects a block including data in the second management unit, in which number of data written in the first and second storage areas after being written in the second storage area as data in the second management unit is larger than a predetermined threshold, as an organizing target block.

14. The semiconductor storage device according to claim 8, wherein the controller preferentially selects a block including data in the second management unit, which is read-accessed more than a predetermined threshold, as an organizing target block.

15. The semiconductor storage device according to claim 1, wherein, in the data organizing processing, the controller collects valid data from a selected organizing target block and rewrites into another block as data in the second management unit when number of addresses in the second management unit, whose data is written in the first and second storage areas after being written in the second storage area as data in the second management unit, exceeds a predetermined threshold.

16. The semiconductor storage device according to claim 15, wherein the controller preferentially selects a block whose write time is older than a predetermined threshold, as an organizing target block.

17. The semiconductor storage device according to claim 15, wherein the controller preferentially selects a block in which number of valid data or a valid data rate is smaller than a predetermined threshold, as an organizing target block.

18. The semiconductor storage device according to claim 15, wherein the controller preferentially selects a block whose write time is older than a predetermined threshold and in which number of valid data or a valid data rate is smaller than a predetermined threshold, as an organizing target block.

19. The semiconductor storage device according to claim 15, wherein the controller preferentially selects a block that is read-accessed more than a predetermined threshold, as an organizing target block.

20. The semiconductor storage device according to claim 21, wherein the controller preferentially selects a block including data in the second management unit, in which number of data written in the first and second storage areas after being written in the second storage area as data in the second management unit is larger than a predetermined threshold, as an organizing target block.

21. The semiconductor storage device according to claim 15, wherein the controller preferentially selects a block including data in the second management unit, which is read-accessed more than a predetermined threshold, as an organizing target block.

22. The semiconductor storage device according to claim 8, wherein, in the data organizing processing, the controller configured to:
collects data in the second management unit, in which a valid data amount in the first management unit in data in the second management unit in an organizing target block or a valid data rate in the first management unit in data in the second management unit in an organizing target block is equal to or more than a predetermined threshold and rewrites into another block as data in the second management unit; and
after performing the rewriting, collects data in the first management unit in an organizing target block and rewrites into another block as data in the second management unit.

23. The semiconductor storage device according to claim 1, wherein the controller collects valid data from a selected organizing target block and rewrites into another block as data in the first management unit when an access frequency from a host apparatus is equal to or more than a threshold.

24. The semiconductor storage device according to claim 23, wherein the controller preferentially selects a block in which number of valid data or a valid data rate is smaller than a predetermined threshold, as an organizing target block.

25. The semiconductor storage device according to claim 23, wherein the controller preferentially selects a block whose write time is older than a predetermined threshold and in which number of valid data or a valid data rate is smaller than a predetermined threshold, as an organizing target block.

26. The semiconductor storage device according to claim 1, wherein the controller collects valid data from a selected organizing target block and rewrites into another block as data in the first management unit when number of unused blocks in the second storage area as a resource usage of the second storage area becomes smaller than a threshold.

27. The semiconductor storage device according to claim 26, wherein the controller preferentially selects a block in which number of valid data or a valid data rate is smaller than a predetermined threshold, as an organizing target block.

28. The semiconductor storage device according to claim 26, wherein the controller preferentially selects a block whose write time is older than a predetermined threshold and in which number of valid data or a valid data rate is smaller than a predetermined threshold, as an organizing target block.

29. The semiconductor storage device according to claim 1, wherein in the data organizing processing, the controller collects valid data from a selected organizing target block and rewrites into another block as data in the first management unit when an access frequency from a host apparatus is less than a threshold.

30. The semiconductor storage device according to claim 29, wherein the controller preferentially selects a block including data in the second management unit, which is write-accessed more than a threshold, as an organizing target block.

31. The semiconductor storage device according to claim 1, wherein, in a case where an access frequency from a host apparatus is equal to or more than a threshold, the controller configured to:
when number of valid data in data in the second management unit in an organizing target block or a valid data rate in data in the second management unit in an organizing target block is less than the threshold, collects the valid data from the organizing target block and rewrites into another block as data in the first management unit; and
when the number of the valid data in the data in the second management unit in the organizing target block or the valid data rate in the data in the second management unit in the organizing target block is equal to or more than the threshold, rewrites the data in the second management unit, in which the number of the valid data or the valid data rate is equal to or more than the threshold, into another block as data in the second management unit without performing conversion of a management unit.

32. The semiconductor storage device according to claim 1, wherein the controller configured to:
collects valid data from a selected organizing target block and rewrites into another block as data in the second management unit when an ambient temperature is equal to or higher than a threshold; and
collects valid data from a selected organizing target block and rewrites into another block as data in the first management unit when the ambient temperature is lower than the threshold.

33. The semiconductor storage device according to claim 1, wherein the controller configured to:
collects valid data from a selected organizing target block and rewrites into another block as data in the second management unit when a power consumption amount of the semiconductor storage device needs to be equal to or more than a threshold; and
collects valid data from a selected organizing target block and rewrites into another block as data in the first management unit when the power consumption amount needs to be less than the threshold.

34. The semiconductor storage device according to claim 1, wherein the controller, when an access frequency from a host apparatus is less than a threshold, selects a block with less valid data amount among blocks whose write time is later than a first threshold, selects a block with less valid data amount among blocks whose write time is older than a second threshold, and rewrites data in selected blocks into other blocks as data in the first or second management unit.

35. A semiconductor storage device comprising:
a first storage area included in a first semiconductor memory capable of random access;
a second storage area included in a nonvolatile second semiconductor memory in which reading and writing is performed by a page unit and erasing is performed by a block unit larger than the page; and
a controller that allocates a storage area of the second semiconductor memory to the second storage area by a block unit, wherein
the controller configured to:
records a first management table for managing data in the second storage area by a first management unit, into the second semiconductor memory;
records a second management table for managing data in the second storage area by a second management unit larger than the first management unit, into the first semiconductor memory;
performs a data flush processing of flushing a plurality of data in a sector unit written in the first storage area to the second storage area as data in the first management unit and updates at least one of the first management table and the second management table;
when a resource usage of the second storage area exceeds a threshold, performs a data organizing processing of collecting valid data from the second storage area and rewriting into another block in the second storage area and updates at least one of the first management table and the second management table; and
in the data organizing processing, when an access frequency from a host apparatus is less than a threshold, collects valid data from a selected organizing target block and rewrites into another block as data in the second management unit.
